(19) United States
(12) Patent Application Publication
(10) Pub. No.: US 2022/0368853 A1
(43) Pub. Date: Nov. 17, 2022

(54) Multimodal Video Conferencing Device

(71) Applicant: Graham SMITH, Toronto (CA)

(72) Inventor: Graham SMITH, Toronto (CA)

(21) Appl. No.: 17/738,076

(22) Filed: May 6, 2022

Related U.S. Application Data
(60) Provisional application No. 63/188,071, filed on May 13, 2021.

(51) Int. Cl. H04N 7/14; H04N 7/15; G06F 3/01

(52) U.S. Cl. CPC H04N 7/142; H04N 7/147; H04N 7/152; G06F 3/016

(57) ABSTRACT

A video conferencing device having a vertically oriented video display device and a horizontally oriented video display device. The video conferencing device also has a desktop surface, a user facing camera, and a table facing camera. The user facing camera is for capturing images of a user positioned in front of the video conferencing device. The table facing camera is for capturing images of the desktop surface.

### RELATED APPLICATION

This application claims the benefit of the May 13, 2021 filing date of U.S. Provisional Patent Application Ser. No. 63/188,071, which is incorporated herein by reference.

### FIELD OF THE INVENTION

This invention relates to a video conferencing device, and more particularly to a mobile, multimodal video conferencing table.

### BACKGROUND OF THE INVENTION

It is known to conduct video conferencing using a computer monitor and a webcam. The applicant has appreciated that known video conferencing equipment provides a limited sense of presence, which can result in less natural and less efficient communication and collaboration.

### SUMMARY OF THE INVENTION

To at least partially overcome some of the disadvantages of previously known devices and methods, in one aspect the present invention provides a video conferencing device comprising: a vertically oriented video display device; a horizontally oriented video display device; a desktop surface; a user facing camera for capturing images of a user positioned in front of the video conferencing device; and a table facing camera for capturing images of the desktop surface.

In further aspects the invention provides:

(A) A video conferencing device comprising: a first video display device; a second video display device; a table top; a user facing camera; and a table facing camera; wherein in at least a first mode of operation of the video conferencing device: the user facing camera captures images of a user positioned in front of the video conferencing device at a first location; the table facing camera captures images of the table top at the first location; the first video display device displays images of a communication partner at a second location; and the second video display device displays images of a work surface at the second location.

(B) The video conferencing device according to (A), wherein, when the video conferencing device is in the first mode of operation: the first video display device is positioned vertically and facing forwardly; the second video display device is positioned horizontally and facing upwardly; and the table top is positioned horizontally, with a table top surface of the table top facing upwardly.

(C) The video conferencing device according to any one of (A) and (B), further comprising a table facing camera support member that is attached to a top portion of the first video display device, the table facing camera support member carrying the table facing camera; wherein the table facing camera support member is movable relative to the first video display device between an extended position, in which the table facing camera is positioned above the table top, and a retracted position, in which the table facing camera is retracted towards the first video display device; and wherein, when the video conferencing device is in the first mode of operation, the table facing camera support member is in the extended position.

(D) The video conferencing device according to any one of (A) to (C), wherein the table facing camera support member comprises: a primary support arm having a first end that is pivotally connected to the top portion of the first video display device and a second end that carries the table facing camera; and a secondary support arm having a first end that is pivotally and slideably connected to the top portion of the first video display device and a second end that is connected to the primary support arm.

(E) The video conferencing device according to any one of (A) to (D), wherein the primary support arm has a telescoping mechanism that allows a length of the primary support arm to be adjusted.

(F) The video conferencing device according to any one of (A) to (E), further comprising a user facing camera support member that is attached to a top portion of the first video display device, the user facing camera support member carrying the user facing camera; wherein the user facing camera support member is movable relative to the first video display device between a retracted position and an extended position, the user facing camera being positioned closer to the top portion of the first video display device when the user facing camera support member is in the retracted position than when the user facing camera support member is in the extended position; and wherein, when the first video display device is positioned vertically, movement of the user facing camera support member between the retracted position and the extended position moves the user facing camera vertically.

(G) The video conferencing device according to any one of (A) to (F), further comprising a haptic interface; wherein, in at least the first mode of operation, the haptic interface is configured to vibrate when: the user touches the haptic interface at the first location, and the communication partner simultaneously touches a haptic device at the second location.

(H) The video conferencing device according to any one of (A) to G), wherein the haptic interface comprises a touch sensitive strip that is positioned between the second video display device and the table top.

(I) The video conferencing device according to any one of (A) to (II), wherein, when the video conferencing device is in the first mode of operation and the communication partner touches the haptic device at the second location, the second video display device displays images of the communication partner touching the haptic device at the second location.

(J) The video conferencing device according to any one of (A) to (I), wherein the haptic interface is configured to vibrate rhythmically at a rate of about 70 pulses per minute.

(K) The video conferencing device according to any one of (A) to (J), wherein the first video display device is movable relative to the second video display device between a display position and a stowed position; wherein, when in the display position, the first video display device is positioned rearwardly of the second video display device and extends above the second video display device; wherein, when in the stowed position, the first video display device is positioned beneath the second video display device; and wherein, when the video conferencing device is in the first mode of operation: the first video display device is in the display position; and the second video display device is positioned rearwardly of the table top.

(L) The video conferencing device according to any one of (A) to K), wherein the first video display device connects to an underside of the second video display device when the first video display device is in the stowed position.

(M) The video conferencing device according to any one of (A) to (L), further comprising: support legs that support the second video display device; support feet that are positioned at bottom ends of the support legs; and a storage member that is supported by the support feet; wherein the storage member has an internal compartment for receiving the first video display device; wherein the first video display device extends vertically upwardly from the storage member when in the display position; wherein the first video display device is received in the internal compartment of the storage member when in the stowed position; wherein the support feet are movable relative to the support legs between an extended position and a retracted position; wherein, when the support feet are in the extended position, the first video display device is positioned rearwardly of the second video display device; wherein, when the support feet are in the retracted position, the first video display device is positioned below the second video display device; wherein the support feet are in the extended position when the first video display device is in the display position; and wherein the support feet are in the retracted position when the first video display device is in the stowed position.

(N) The video conferencing device according to any one of (A) to (M), wherein the support legs are movable relative to the support feet between a raised position and a lowered position; and wherein a height of the second video display device is selectable by moving the support legs between the raised position and the lowered position.

(O) The video conferencing device according to any one of (A) to (N), wherein the table top is moveable between an unfolded position and a folded position; wherein, when in the unfolded position, the table top is positioned horizontally and forwardly of the second video display device, with the table top surface of the table top facing upwardly; and wherein, when in the folded position, the table top is positioned horizontally and above the second video display device, with the table top surface of the table top facing downwardly.

(P) The video conferencing device according to any one of (A) to (O), further comprising a user facing camera support member that is attached to the top portion of the first video display device, the user facing camera support member carrying the user facing camera; wherein the user facing camera support member is movable relative to the first video display device between a retracted position and an extended position, the user facing camera being positioned closer to the top portion of the first video display device when the user facing camera support member is in the retracted position than when the user facing camera support member is in the extended position; and wherein, when the first video display device is positioned vertically, movement of the user facing camera support member between the retracted position and the extended position moves the user facing camera vertically.

(Q) The video conferencing device according to any one of (A) to (P), further comprising a haptic interface; wherein, in at least the first mode of operation, the haptic interface is configured to vibrate when: the user touches the haptic interface at the first location, and the communication partner simultaneously touches a haptic device at the second location; wherein the haptic interface comprises a touch sensitive strip that is positioned between the second video display device and the table top; wherein, when the video conferencing device is in the first mode of operation and the communication partner touches the haptic device at the second location, the second video display device displays images of the communication partner touching the haptic device at the second location; and wherein the haptic interface is configured to vibrate rhythmically at a rate of about 70 pulses per minute.

(R) The video conferencing device according to any one of (A) to (Q), wherein the first video display device is movable relative to the second video display device between a display position and a stowed position; wherein, when in the display position, the first video display device is positioned rearwardly of the second video display device and extends above the second video display device; wherein, when in the stowed position, the first video display device is positioned beneath the second video display device; wherein, when the video conferencing device is in the first mode of operation: the first video display device is in the display position; and the second video display device is positioned rearwardly of the table top; and wherein the first video display device connects to an underside of the second video display device when the first video display device is in the stowed position.

(S) The video conferencing device according to any one of (A) to (R), further comprising: support legs that support the second video display device; support feet that are positioned at bottom ends of the support legs; and a storage member that is supported by the support feet; wherein the storage member has an internal compartment for receiving the first video display device; wherein the first video display device extends vertically upwardly from the storage member when in the display position; wherein the first video display device is received in the internal compartment of the storage member when in the stowed position; wherein the support feet are movable relative to the support legs between an extended position and a retracted position; wherein, when the support feet are in the extended position, the first video display device is positioned rearwardly of the second video display device; wherein, when the support feet are in the retracted position, the first video display device is positioned below the second video display device; wherein the support feet are in the extended position when the first video display device is in the display position; wherein the support feet are in the retracted position when the first video display device is in the stowed position; wherein the support legs are movable relative to the support feet between a raised position and a lowered position; and wherein a height of the second video display device is selectable by moving the support legs between the raised position and the lowered position.

(T) The video conferencing device according to any one of (A) to (S), wherein the table top is moveable between an unfolded position and a folded position; wherein, when in the unfolded position, the table top is positioned horizontally and forwardly of the second video display device, with the table top surface of the table top facing upwardly; wherein, when in the folded position, the table top is positioned horizontally and above the second video display device, with the table top surface of the table top facing downwardly; and wherein the support feet have wheels.

(U) A video conferencing system comprising two or more of the aforementioned video conferencing devices according to any one of (A) to (T); wherein, when a first one of the video conferencing devices is used by the user at the first location, in the first mode of operation, to have a video conference with the communication partner at the second location using a second one of the video conferencing devices, in the first mode of operation: the user facing camera of the second one of the video conferencing devices captures images of the communication partner in front of the second one of the video conferencing devices at the second location; the table facing camera of the second one of the video conferencing devices captures images of the table top at the second location; the first video display device of the second one of the video conferencing devices displays images of the user at the first location; and the second video display device of the second one of the video conferencing devices displays images of the table top at the first location.

(V) A method comprising: providing a user with the aforementioned video conferencing device according to any one of (A) to (T); using the user facing camera to capture images of the user positioned in front of the video conferencing device; using the table facing camera to capture images of the table top; transmitting the images captured by the user facing camera and the table facing camera to the communication partner; receiving images of the communication partner and images of the work surface from the communication partner; displaying the images of the communication partner on the first video display device; and displaying the images of the work surface on the second video display device.

### BRIEF DESCRIPTION OF THE DRAWINGS

Further aspects and advantages of the invention will appear from the following description taken together with the accompanying drawings, in which:

FIG. 1 is a front perspective view of a video conferencing table in accordance with a first embodiment of the present invention, showing the video conferencing table in a first configuration;

FIG. 2 is a right side perspective view of the video conferencing table shown in FIG. 1, showing the video conferencing table in the first configuration;

FIG. 3 is a front perspective view of the video conferencing table shown in FIG. 1, showing the video conferencing table in a second configuration;

FIG. 4 is a rear perspective view of the video conferencing table shown in FIG. 1, showing the video conferencing table in the second configuration;

FIG. 5 is a front perspective view of the video conferencing table shown in FIG. 1, showing the video conferencing table in a third configuration;

FIG. 6 is a front perspective view of the video conferencing table shown in FIG. 1, showing the video conferencing table in a fourth configuration;

FIG. 7 is a front perspective view of the video conferencing table shown in FIG. 1, showing the video conferencing table in a fifth configuration;

FIG. 8 is a front perspective view of the video conferencing table shown in FIG. 1, showing the video conferencing table in a sixth configuration and a seventh configuration;

FIG. 9 is a rear perspective view of the video conferencing table shown in FIG. 1, showing the video conferencing table in the sixth configuration and the seventh configuration;

FIG. 10 is a perspective view of the video conferencing table shown in FIG. 1, showing the video conferencing table in each of the first to seventh configurations;

FIG. 11 is a front perspective view of the video conferencing table shown in FIG. 1, showing the video conferencing table being used in the first configuration;

FIG. 12 is a front perspective view of a video conferencing table in accordance with a second embodiment of the present invention, showing the video conferencing table being used in a first configuration;

FIG. 13 is a front perspective view of the video conferencing table shown in FIG. 12, showing the video conferencing table being used in the first configuration;

FIG. 14 is a front perspective view of the video conferencing table shown in FIG. 12, showing the video conferencing table in the first configuration;

FIG. 15 is a top perspective view of the video conferencing table shown in FIG. 12, showing the video conferencing table in the first configuration;

FIG. 16 is a front perspective view of the video conferencing table shown in FIG. 12, showing the video conferencing table in a second configuration;

FIG. 17 is a top perspective view of the video conferencing table shown in FIG. 12, showing the video conferencing table in the second configuration;

FIG. 18 is a front perspective view of the video conferencing table shown in FIG. 12, showing the video conferencing table being used in a third configuration;

FIG. 19 is a front perspective view of the video conferencing table shown in FIG. 12, showing the video conferencing table being used in a fourth configuration;

FIG. 20 is a front perspective view of the video conferencing table shown in FIG. 12, showing the video conferencing table in a fifth configuration;

FIG. 21 is a front perspective view of the video conferencing table shown in FIG. 12, showing the video conferencing table being used in the second configuration;

FIG. 22 is a front perspective view of the video conferencing table shown in FIG. 12, showing the video conferencing table being used in a sixth configuration;

FIG. 23 is a front perspective view of the video conferencing table shown in FIG. 12, showing the video conferencing table being used in a seventh configuration;

FIG. 24 is a front perspective view of the video conferencing table shown in FIG. 12, showing the video conferencing table in the seventh configuration;

FIG. 25 is a top perspective view of the video conferencing table shown in FIG. 12, showing a first participant touching a haptic bar of the table;

FIG. 26 is a top perspective view of the video conferencing table shown in FIG. 12, showing a second participant touching the haptic bar;

FIG. 27 is a top perspective view of the video conferencing table shown in FIG. 12, showing both the first participant and the second participant touching the haptic bar;

FIG. 28 is a front perspective view of the video conferencing table shown in FIG. 12, showing the video conferencing table being used in the first configuration with a first picture in picture display style;

FIG. 29 is a front perspective view of the video conferencing table shown in FIG. 12, showing the video conferencing table being used in the first configuration with a second picture in picture display style;

FIG. 30 is a front perspective view of the video conferencing table shown in FIG. 12, showing the video conferencing table in an eighth configuration;

FIG. 31 is a front perspective view of a video conferencing table in accordance with a third embodiment of the present invention, showing the video conferencing table in a first configuration;

FIG. 32 is a front perspective view of the video conferencing table shown in FIG. 31, showing the video conferencing table in a second configuration; and

FIG. 33 is a right side perspective view of the video conferencing table shown in FIG. 31, showing the video conferencing table in the second configuration.

### DETAILED DESCRIPTION OF THE DRAWINGS

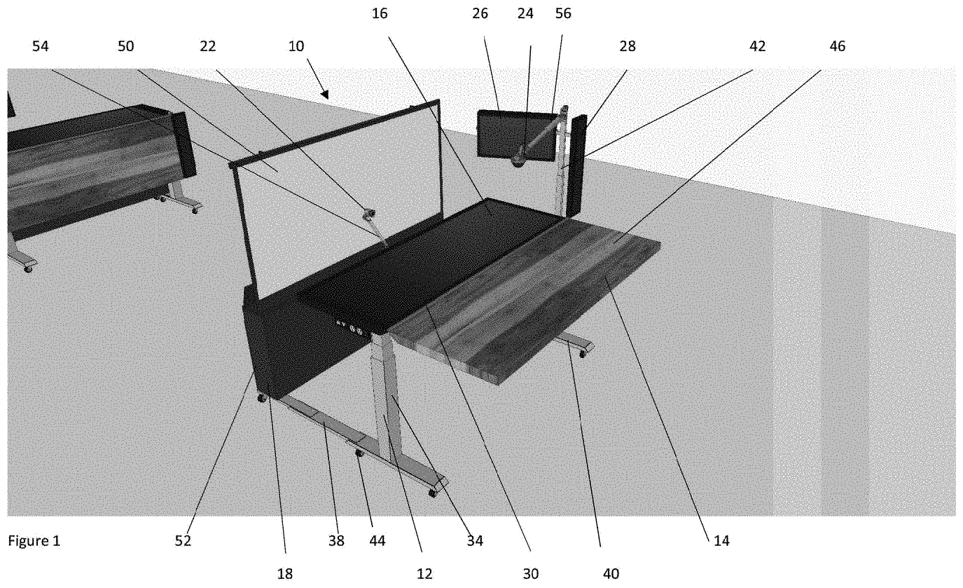

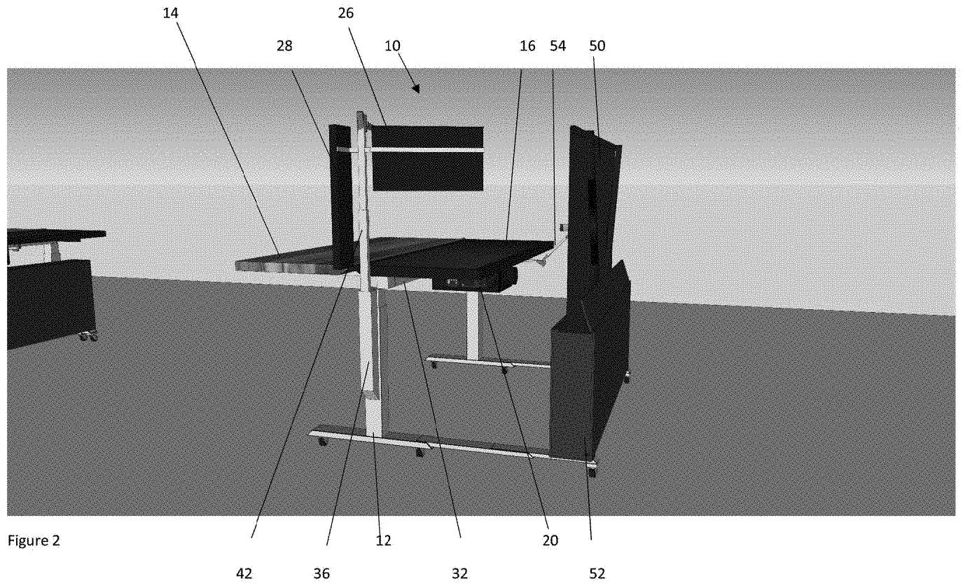

Reference is made to FIG. 1, which shows a video conferencing device 10 in accordance with a first embodiment of the present invention. More particularly, the video conferencing device 10 is a mobile, multimodal video conferencing table 10. As can be seen in FIGS. 1 and 2, the table 10 includes a frame 12, a table top 14, a table display device 16, a projection screen assembly 18, a projector 20, a user facing camera 22, a table facing camera 24, a side display device 26, a speaker 28, and a haptic bar 30. The user facing camera 22 may also be referred to as the main camera 22, and the table facing camera 24 may also be referred to as the overhead camera 24. The table 10 may also be referred to as a web table 10 or web table 10.

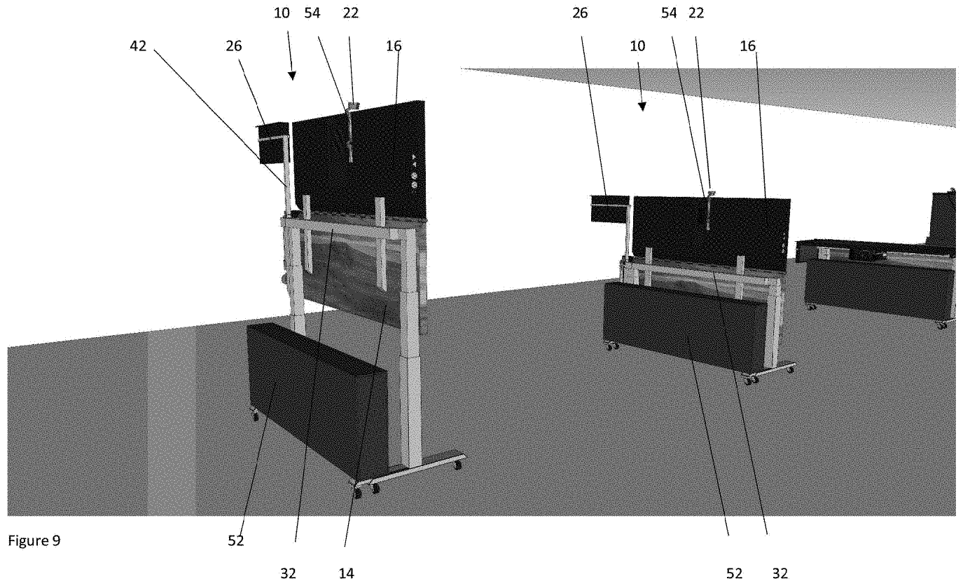

As can be seen in FIG. 2, the frame 12 has a horizontal support bar 32, a telescoping left leg 34, a telescoping right leg 36, a telescoping left foot 38, a telescoping right foot 40, and a telescoping side arm 42. The support bar 32 extends from the top of the left leg 34 to the top of the right leg 36. The height of the support bar 32 can be adjusted by extending or retracting the telescoping legs 34, 36 between the lowered position shown in FIG. 1 and the raised position shown in FIG. 9.

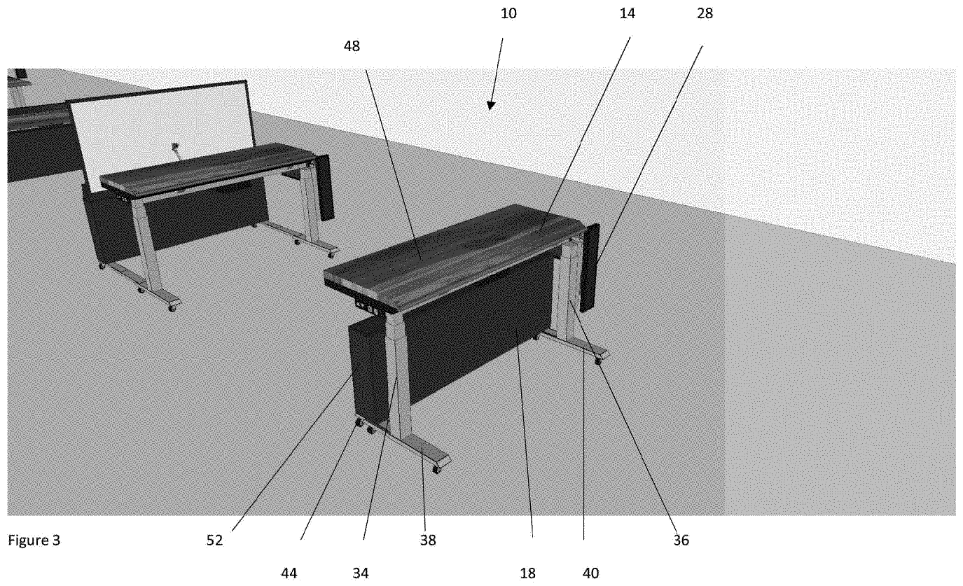

The left foot 38 and the right foot 40 support the left leg 34 and the right leg 36, respectively. Each of the left foot 38 and the right foot 40 extend horizontally in the front-to-back direction, and have three swivel wheels 44 that permit the table 10 to be rolled in any direction. The left foot 38 and the right foot 40 each have a telescoping rear portion that can extend and retract horizontally between the retracted position shown in FIG. 3 and the extended position shown in FIGS. 1 and 2.

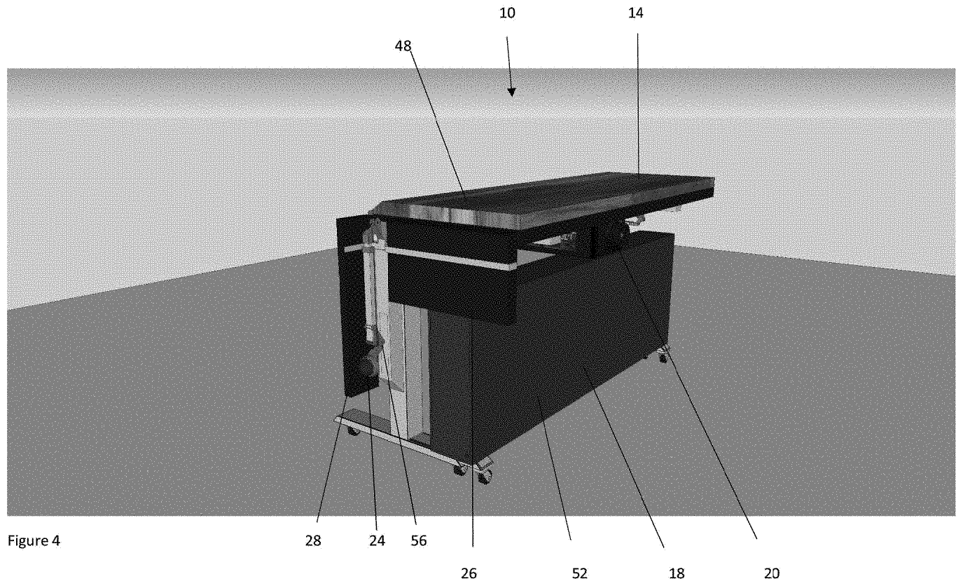

As can be seen in FIG. 2, the side arm 42 is attached to the right leg 36. The side arm 42 has a telescoping mechanism that allows the side arm 42 to be extended vertically from the right leg 36 to the extended position shown in FIG. 2. The side arm 42 can also be retracted to the retracted position shown in FIGS. 3 and 4, in which the top of the side arm 42 is at approximately the same height as the support bar 32.

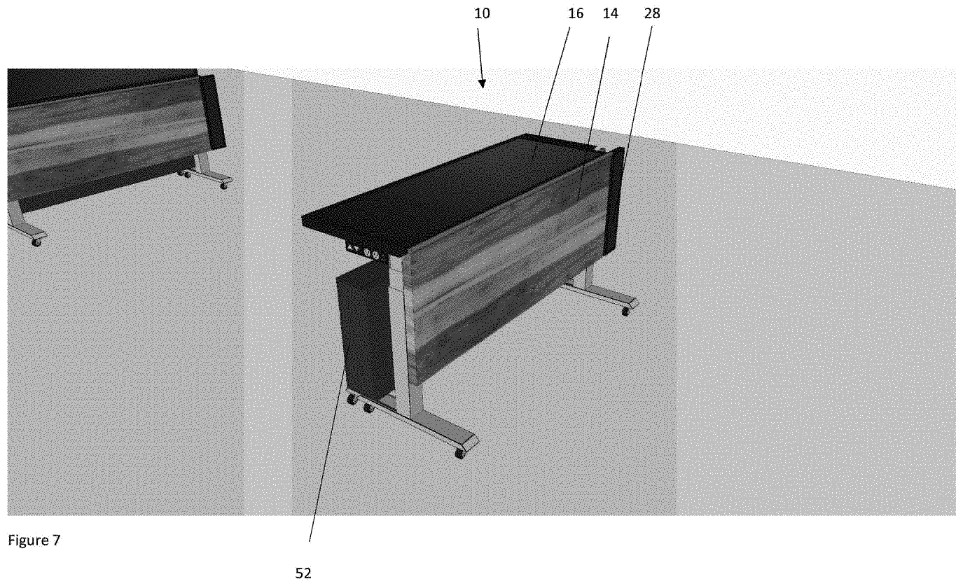

As can be seen in FIG. 1, the table top 14 is a rectangular panel that presents an upwardly facing desktop surface 46. The table top 14 may, for example, be made from wood, though any other suitable material such as metal or plastic could also be used. The table top 14 is hingedly supported by the support bar 32, such that the height of the table top 14 can be adjusted by extending or retracting the telescoping left and right legs 34, 36. The hinged connection of the table top 14 to the support bar 32 allows the table top 14 to be pivoted over top of the table display device 16 as shown in FIGS. 3 to 5. When in the folded over position shown in FIGS. 3 to 5, the underside of the table top 14 faces upwards to provide an alternative desk top surface 48. The table top 14 can also be pivoted downwardly from the horizontal position shown in FIG. 1 to the vertical position shown in FIGS. 7 to 9.

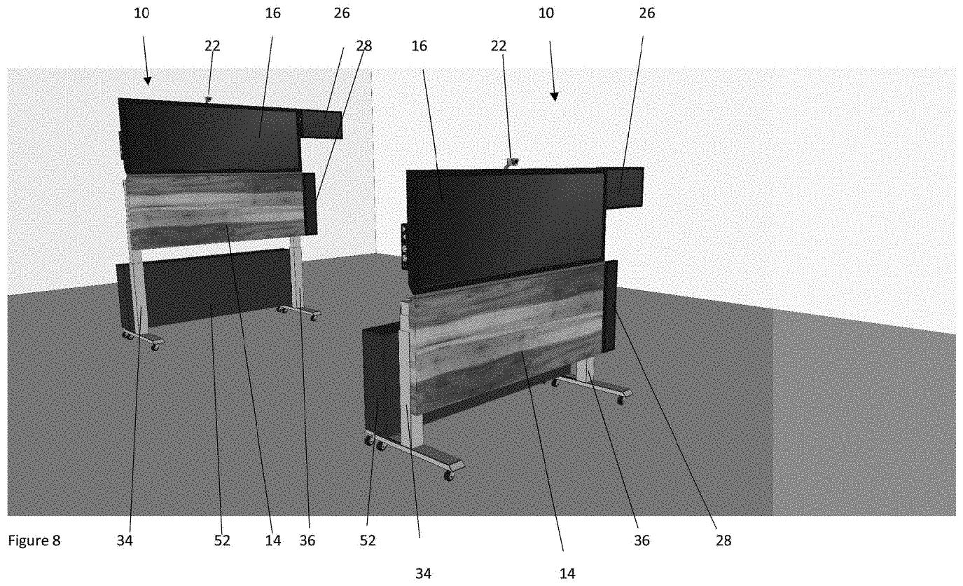

The table display device 16 is an electronic device that is capable of displaying video images, such as a television screen or a computer monitor. The table display device 16 is rectangular and has approximately the same dimensions as the table top 14. The table display device 16 is positioned adjacent to the table top 14, and is supported by the support bar 32 by a hinged connection, which allows the table display device 16 to be pivoted between the horizontal position shown in FIGS. 1 to 7 and the vertical position shown in FIGS. 8 and 9. The height of the table display device 16 can be adjusted by extending or retracting the telescoping left and right legs 34, 36.

As can be seen in FIG. 1, the projection screen assembly 18 comprises a projection screen 50 and a storage box 52. The projection screen 50 fits inside the storage box 52 when in a stowed position, as shown in FIGS. 3 and 4, and is vertically extendible from the storage box 52 to the extended position shown in FIGS. 1 and 2. The storage box 52 is supported by the telescoping rear portions of the left foot 38 and the right foot 40. When the projection screen 50 is stowed within the storage box 52, the telescoping rear portions of the left foot 38 and the right foot 40 can be retracted to the retracted position as shown in FIGS. 3 and 4. When in the stowed and retracted position, the projection screen assembly 18 is positioned below the table display device 16, which makes the table 10 more compact and easier to move. When the telescoping rear portions of the left foot 38 and the right foot 40 are extended rearwardly and the projection screen 50 is extended vertically from the storage box 52, as shown in FIGS. 1 and 2, the projection screen 50 extends above the table display device 16 and is available for displaying video images projected from the projector 20.

As can be seen in FIG. 2, the projector 20 is mounted to the bottom of the table display device 16, facing towards the projection screen 50. The projector 20 is configured to project video images onto the projection screen 50.

As is also shown in FIG. 2, the user facing camera 22 is also mounted to the bottom of the table display device 16. The user facing camera 22 is mounted on an adjustable user facing camera arm 54 that allows the position of the user facing camera 22 to be adjusted. When in the configuration shown in FIG. 1, the user facing camera 22 faces towards the front of the table 10, and is positioned near the middle of the projection screen 50. The relative positions of the user facing camera 22 and the projector 20 are preferably selected so that the user facing camera 22 does not block the image projected by the projector 20 onto the projection screen 50. The user facing camera 22 is retractable for storage below the table display device 16, as shown in FIG. 4. The user facing camera 22 can also be arranged to face forwardly above the table display device 16 when the table display device 16 is arranged vertically as shown in FIGS. 8 and 9.

As can be seen in FIG. 1, the table facing camera 24 is attached to the telescoping side arm 42 of the frame 12 by an adjustable table facing camera arm 56. When in the configuration shown in FIG. 1, the adjustable table facing camera arm 56 extends horizontally above the table top 14, with the table facing camera 24 facing downwardly at the desk top surface 46. The adjustable table facing camera arm 56 can also be folded and retracted to the stowed position shown in FIG. 4.

The side display device 26 is an electronic device that is capable of displaying video images, such as a television, a computer monitor, or a tablet. Preferably, the side display device 26 has a touch screen, though this is not required. The side display device 26 is mounted to the telescoping side arm 42, and is positioned above and to the right of the table display device 16 when the side arm 42 is in the extended position as shown in FIG. 1. When the side arm 42 is retracted as shown in FIG. 4, the top of the side display device 26 is at approximately the same height as the table display device 16.

The speaker 28 is also mounted to the side arm 42, and is positioned above and to the right of the table display device 16 when the side arm 42 is in the extended position as shown in FIG. 1. When the side arm 42 is retracted as shown in FIG. 4, the top of the speaker 28 is at approximately the same height as the table display device 16.

The haptic bar 30 is a touch sensitive strip that extends between the table top 14 and the table display device 16, and can be seen in FIG. 1. The haptic bar 30 is able to sense when a user touches the bar 30, and is also able to vibrate. Some of the possible uses of the haptic bar 30 will be described in more detail below.

Although not visible in the drawings, the table 10 also preferably includes a variety of different computer components, including one or more processors, memories, wired and/or wireless communication devices, and power cables. The table 10 also preferably includes one or more microphones for detecting and recording audio, including speech.

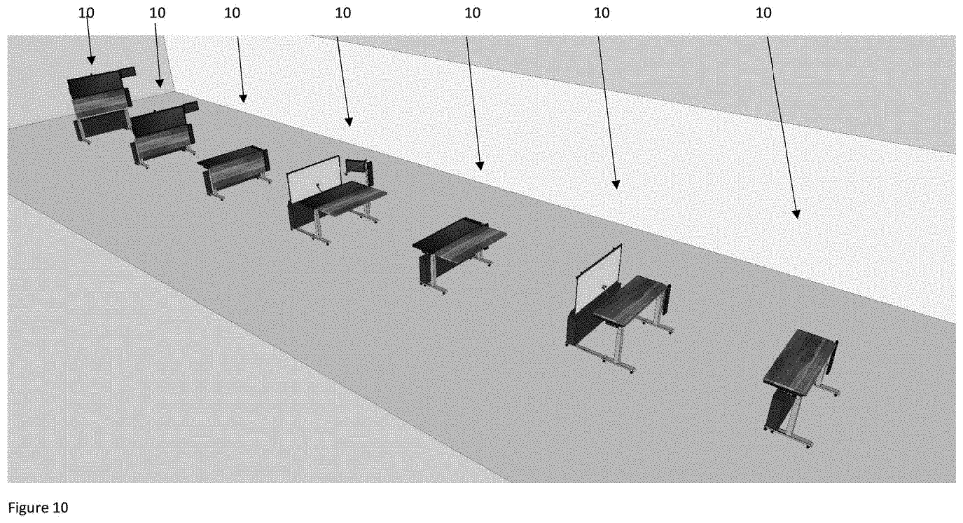

Various preferred methods of using the table 10 will now be described with reference to FIGS. 1 to 11.

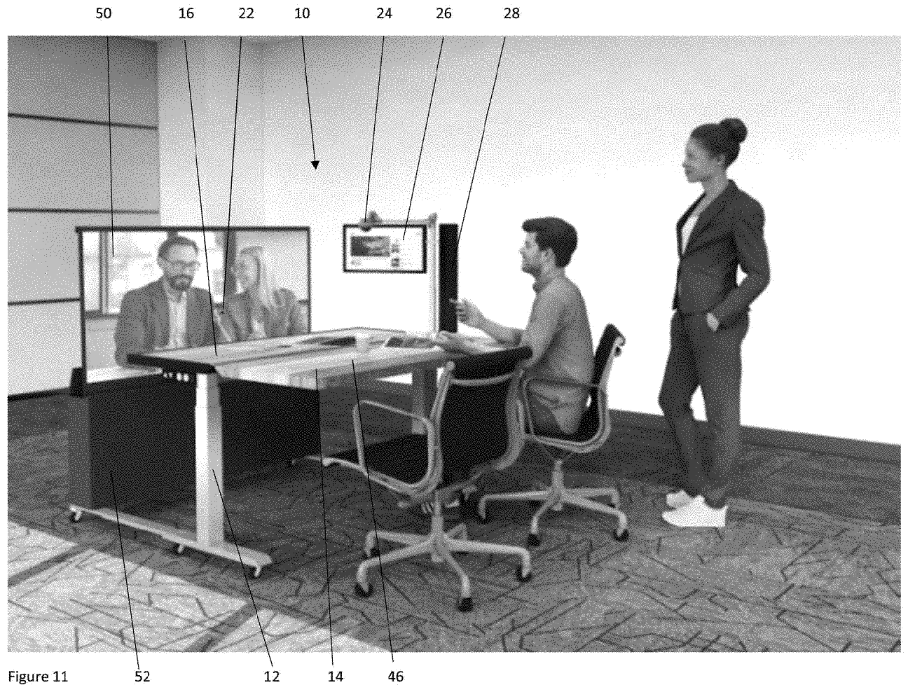

The table 10 preferably has a variety of different configurations or modes that facilitate different possible uses. When in the configuration shown in FIG. 1, the table 10 can be used for video conferencing, as is shown in FIG. 11. Preferably, each participant in the video conference has an identical table 10, or at least a similar table 10. Typically, the participants in the video conference will be located at different locations, which will be referred to as locations A and B in the description below.

When the table 10 is in the configuration shown in FIGS. 1 and 11, the users at location A can position themselves at the front of the table 10, optionally seated or standing. When positioned in front of the table 10, the user facing camera 22 is able to capture video images of the users, which are transmitted to the table 10 at location B, preferably over the internet. The images of the users at location A are then projected onto the projection screen 50 at location B. The images of the users at location B are likewise projected onto the projection screen 50 at location A. The projected images are preferably life size, to give an enhanced sense of presence. The participants are also able to speak to each other using their respective microphones and speakers 28.

The table facing camera 24 captures video images of the desk top surface 46 of the table top 14 at location A, and the images are transmitted to the table 10 at location B, where they are displayed on the table display device 16. The video images of the desk top surface 46 at location B are likewise displayed on the table top display 16 at location A. The images displayed on the table display device 16 are preferably life size. This gives the participants in the two locations the sense of having a shared table 10, with for example the users' hands and documents placed on their respective desk top surfaces 46 being visible on the table display device 16 at the other location. This preferably provides an enhanced sense of presence, and also facilitates effective communication and collaboration by, for example, allowing the users to easily show each other documents, drawings, and/or objects merely by placing them on the desk top surface 46.

The sense of presence can also preferably be enhanced through use of the haptic bar 30. For example, in one preferred embodiment the haptic bar 30 is configured to vibrate in a heartbeat-like pulse when the users at both locations touch their respective haptic bars 30. This may be used, for example, as a greeting protocol akin to a handshake, with the sense of touch being used to further enhance the impression that the users are sharing a common physical space.

The side display device 26 can be used in any desired manner to further enhance and facilitate the communication and collaboration between the users. For example, graphics such as a slide deck can be displayed on the side display device 26.

The table 10 is preferably highly adaptable, and can be adjusted or reconfigured in a number of different ways to facilitate different uses. For example, the table 10 can be reconfigured from the video conferencing mode shown in FIGS. 1 and 2 to the desk or storage mode shown in FIGS. 3 and 4. To move from the configuration shown in FIG. 1 to the configuration shown in FIG. 3, the projection screen 50 is retracted into the storage box 50, and the left and right feet 38, 40 are retracted so that the storage box 50 is positioned below the table display device 16. The table top 14 is also folded over top of the table display device 16, and the adjustable user facing camera arm 54, the adjustable table face camera arm 56, and the side arm 42 are all retracted to their respective stowed positions.

When the table 10 is in the desk or storage mode shown in FIG. 3, the table 10 takes up less room and can, for example, be more easily stored or transported to a new location, for example by rolling the table 10 across floors, through doorways, and into elevators using the swivel wheels 44. The table 10 can also be used as a desk or a work station, with for example the alternative desk top surface 48 being used to carry pens, papers, laptop computers, and/or other work materials. The height of the table top 14 can also be adjusted as desired by extending or retracting the left and right legs 34, 36, for example to allow a user to work at the table 10 while sitting or while standing. The speaker 28 can also be used while in the desk or storage mode, to for example play music.

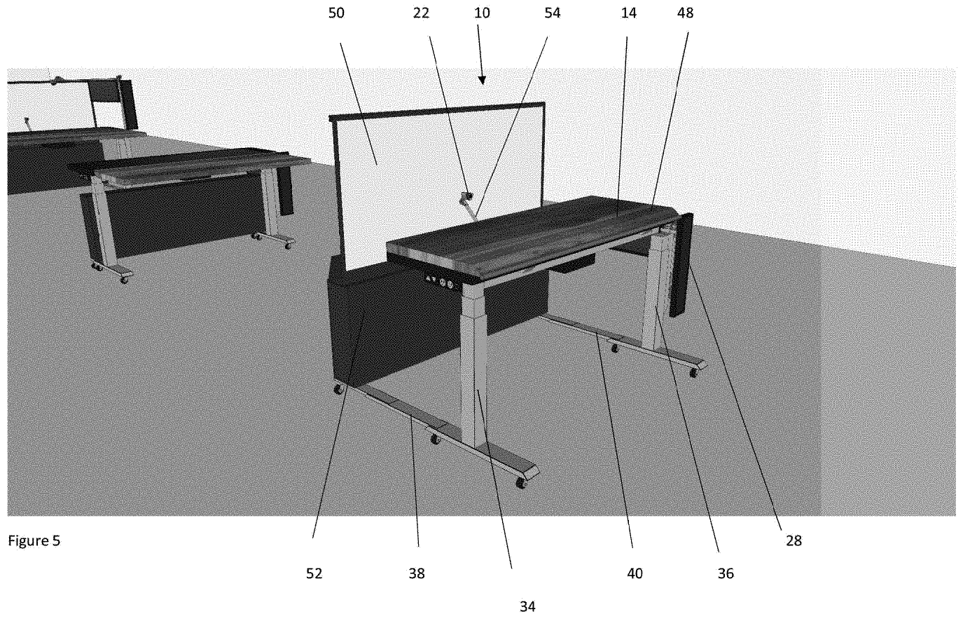

The table 10 can also be reconfigured to the front facing video conferencing mode shown in FIG. 4. In this configuration, the left and right feet 38, 40 are extended rearwardly, and the projection screen 50 is extended vertically from the storage box 52. The adjustable user facing camera arm 54 is also extended, with the user facing camera 22 facing towards the front of the table 10. The table top 14 is folded over the table display device 16, and the side arm 42 and the table facing camera 24 are in their retracted and stowed positions. When in this configuration, the projector 20, the projection screen 50, the user facing camera 22, and the speaker 28 can be used for a video conference, with life size images of the participants projected onto the projection screen 50, similarly to the full video conferencing mode shown in FIGS. 1 and 2. However, when in the front facing video conferencing mode shown in FIG. 5, the table display device 24 is not used for displaying the participants' desk top surfaces 46.

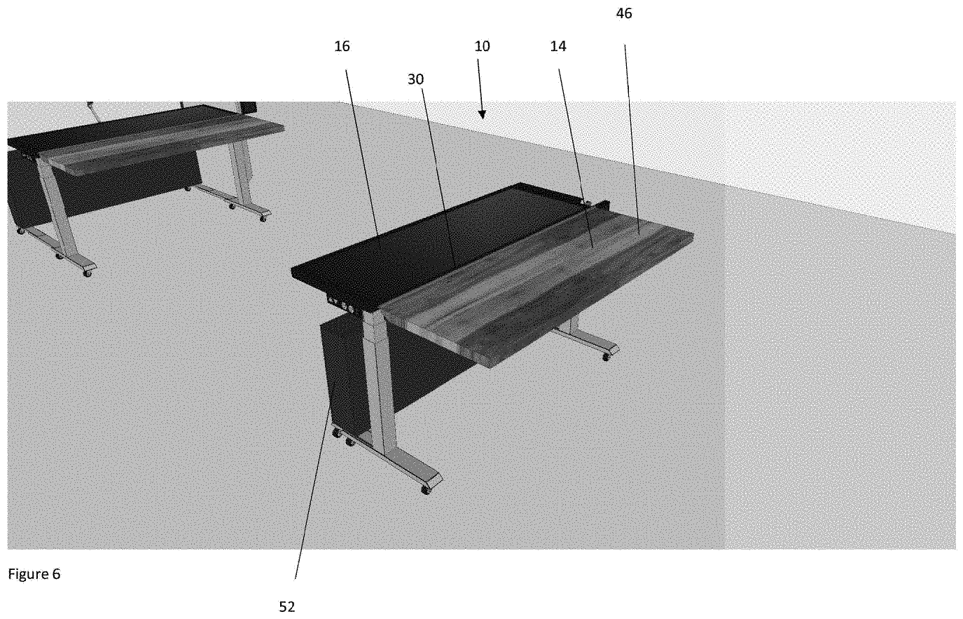

The table 10 can also be reconfigured to the horizontal table and display mode shown in FIG. 6. In this configuration, the projection screen 50 is retracted into the storage box 52, and the storage box 52 is stowed underneath the table display device 16. When in this configuration, the desk top surface 46 can be used as a work surface, to for example carry pens, papers, objects, and/or other physical work materials, and the table display device 16 can be used to display electronic work materials, such as electronic documents, models, presentations, and/or videos.

The table 10 can also be reconfigured to the horizontal display mode shown in FIG. 7. This configuration is similar to the configuration shown in FIG. 6, except that the table top 14 is folded down to a vertical orientation. When in the configuration shown in FIG. 7, the table display device 16 can be used to display electronic work materials, such as electronic documents, models, presentations, and/or videos. Preferably, the table display device 16 has a touch screen that allows the electronic work materials to be manipulated by a user touching the touch screen.

The table 10 can also be reconfigured to the vertical teleconference mode shown in FIGS. 8 and 9. When in this mode, both the table display device 16 and the table top 14 are arranged vertically, and the projection screen 50 is retracted and stored in the storage box 52. The user facing camera 22 is arranged to face forward from above the table display device 16. The side arm 42 is also extended to position the side display device 26 adjacent to the table display device 16. The height of the table 10 can be adjusted by extending or retracting the left and right legs 34, 36.

When in the configurations shown in FIGS. 8 and 9, the table 10 can be used for video conferencing, with the user facing camera 22 capturing images of the users at each location, which are then displayed on the table display device 16 at the other location. The configurations shown in FIGS. 8 and 9 might be used, for example, when the participants in the video conference are standing, and the height of the table 10 can be adjusted based on the height of the users.

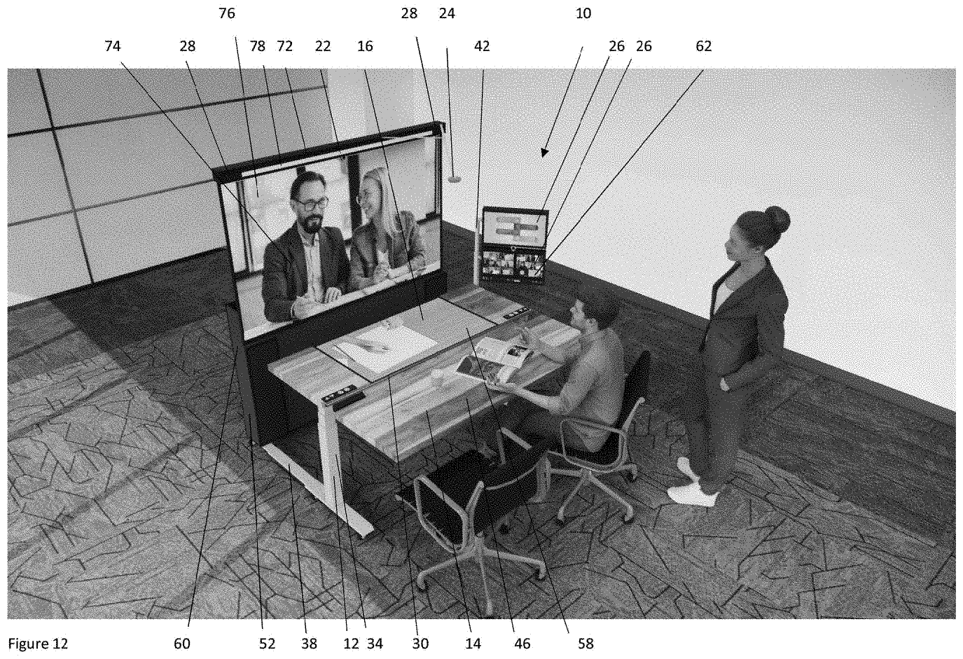

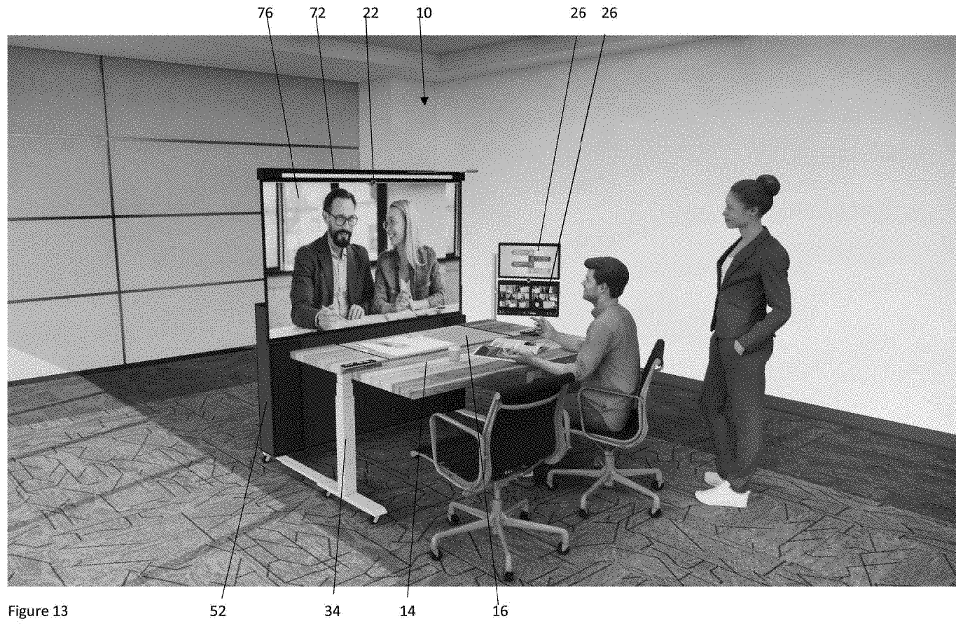

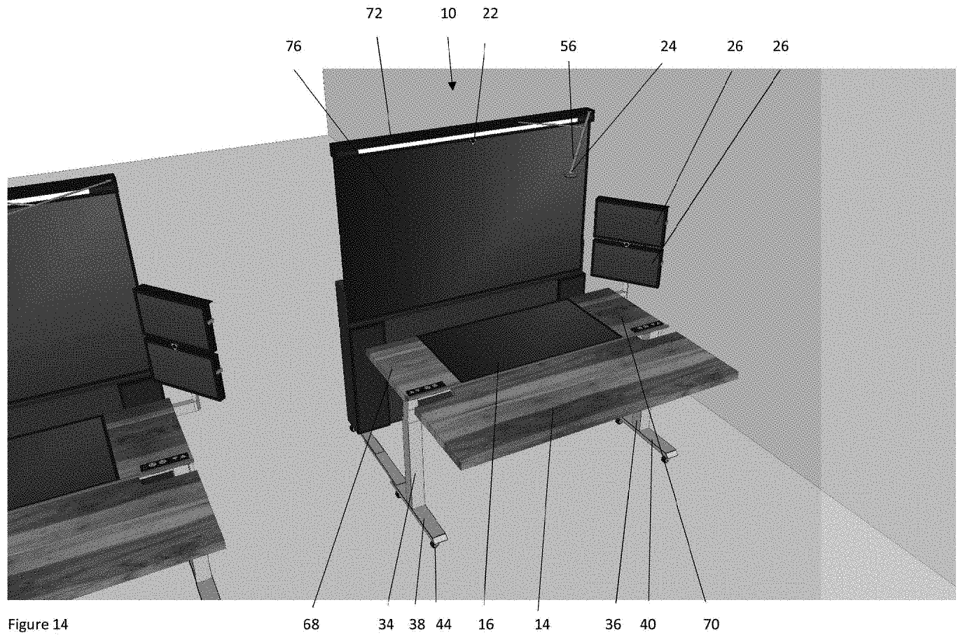

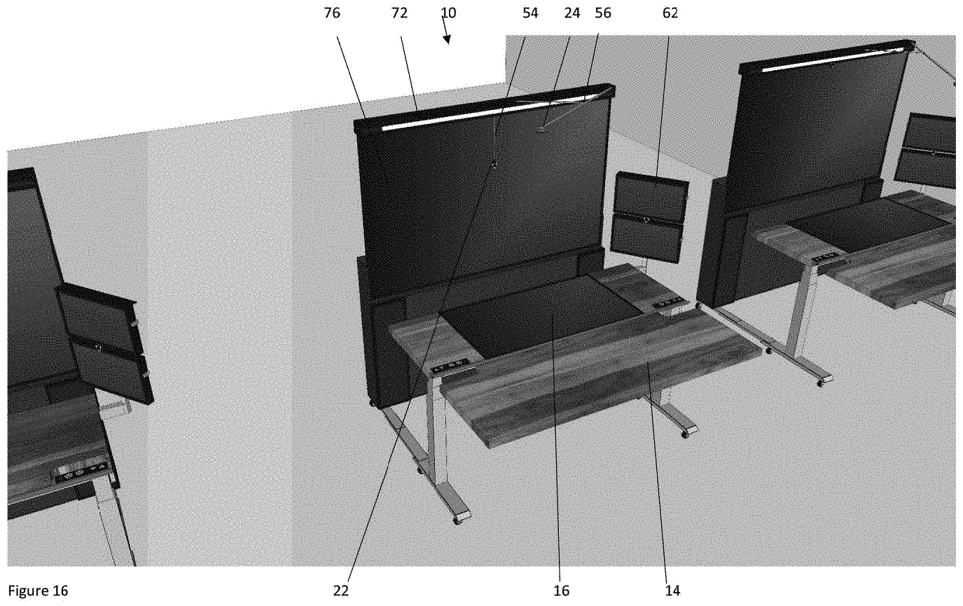

Reference is now made to FIGS. 12 to 30, which show a multimodal, mobile, video conferencing table 10 in accordance with a second embodiment of the present invention. The table 10 shown in FIGS. 12 to 30 is generally similar to the table 10 shown in FIGS. 1 to 11. To avoid repetition, in the description below only the features of the table 10 shown in FIGS. 12 to 30 that differ from those of the table 10 shown in FIGS. 1 to 11 will be described in detail. Like numerals are used to denote like components.

The table 10 shown in FIGS. 12 to 30 includes a frame 12, a table top 14, a table display assembly 58, a vertical display assembly 60, a side display assembly 62, and a haptic bar 30.

The frame 12 includes a horizontal support bar 32, a telescoping left leg 34, a telescoping right leg 36, a telescoping left foot 38, and a telescoping right foot 40. The support bar 32 supports the table top 14 and the table display assembly 58.

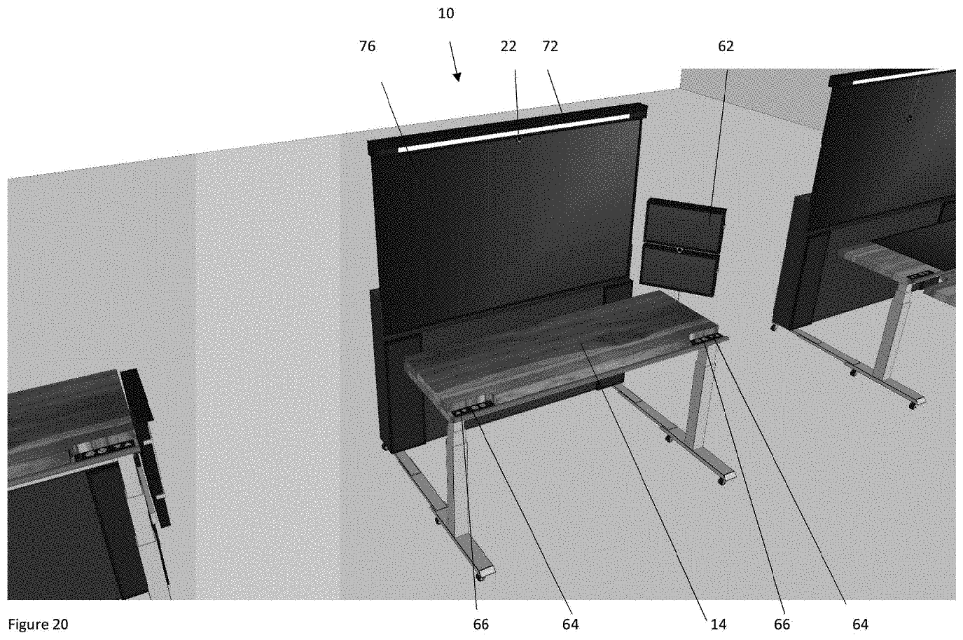

The table top 14 is generally rectangular, with cut-outs 64 at the rear left and right corners of the table top 14. As in the first embodiment of the invention described above, the table top 14 has a hinged connection to the support bar 32 which permits the table top 14 to be folded over on top of the table display assembly 58 as shown in FIG. 20. When in the folded over position, the cut-outs 64 are aligned with control panels 66 positioned on the front left and right corners of the table display assembly 62, which allows the control panels 66 to be accessed when in the folded over position.

The table display assembly 58 includes a left side table portion 68 and a right side table portion 70, which are positioned on the left and right sides of a central table display device 16. The left side table portion 68 and the right side table portion 70 are preferably made from the same material as the table top 14, so as to have a matching appearance. The left side table portion 68, the right side table portion 70, and the table top 14 may, for example, be made from wood, or any other suitable material. The left side table portion 68 and the right side table portion 70 provide a space beside the table display device 16 to carry work materials, such as writing utensils and paper.

The control panels 66 are embedded in the front left corner of the left side table portion 68 and the front right corner of the right side table portion 70, respectively. The control panels 66 include buttons for controlling the operation of the table 10. The control panels 66 may, for examine, include buttons for controlling the height of the support bar 32, sound volume, microphone muting and unmuting, power on and off for one or more components of the table 10, the images and display style of the displays; the operating mode and configuration of the table 10, and/or any other desired parameter to be adjusted or controlled. The control panels 66 also preferably include ports for providing power and/or data communication, such as power outlets and USB ports.

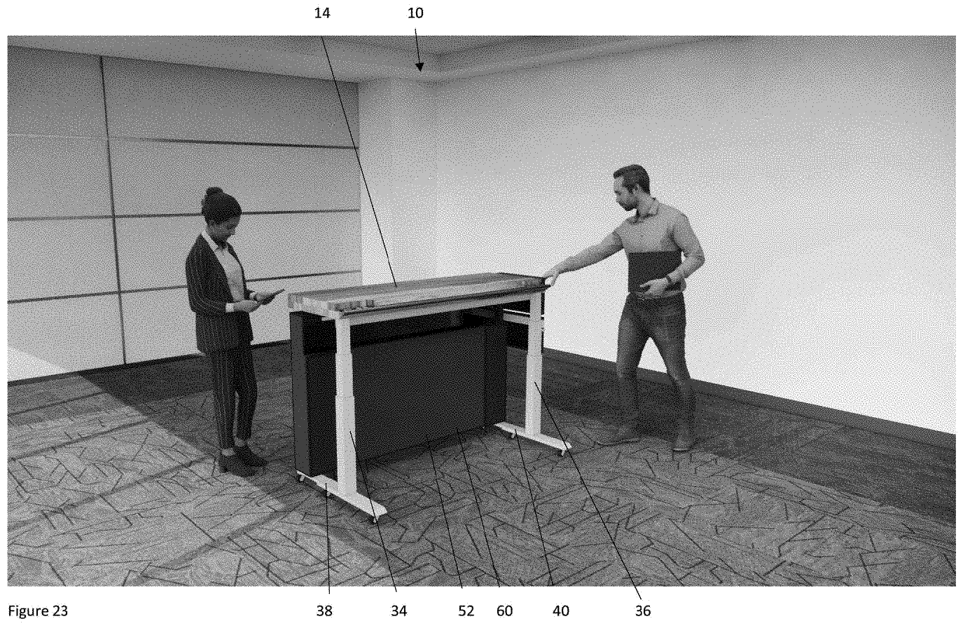

The table display device 16 is an electronic device that is capable of displaying video images, such as a television screen or a computer monitor. Preferably, the table display device 16 is large enough to display life size images of objects such as a user's hands, but small enough that the table 10 is able to easily fit through doorways when in the desk or mobile mode shown in FIG. 23. The table display device 16 may, for example, be a 47 or 50 inch television screen.

The vertical display assembly 60 includes a storage box 52 and a vertical display device 76 that can be stored in the storage box 52, as in FIG. 23, or extended vertically from the storage box 52, as in FIG. 12. The storage box 52 is supported by the rear telescoping portions of the left and right feet 38, 40, and can be positioned rearwardly of the table display assembly 58 when the vertical display assembly 60 is extended as in FIG. 12, and can be positioned underneath the table display assembly 58 when in the stowed position shown in FIG. 23.

The vertical display device 76 is an electronic device capable of displaying video images, such as a television screen or a computer monitor. The vertical display device 76 is preferably large enough to display life size images of people, and for example may be a 75 inch television screen.

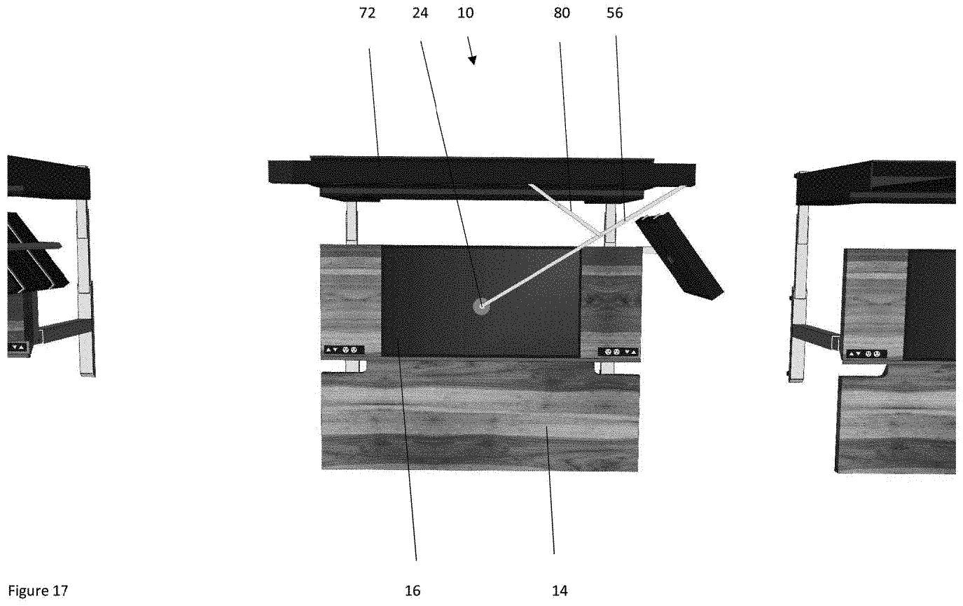

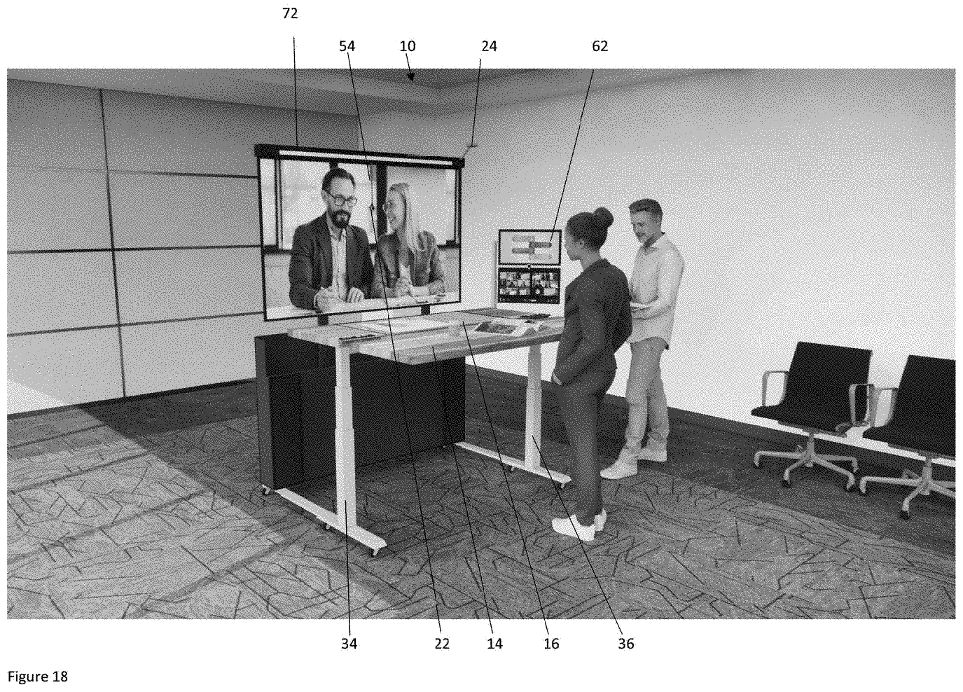

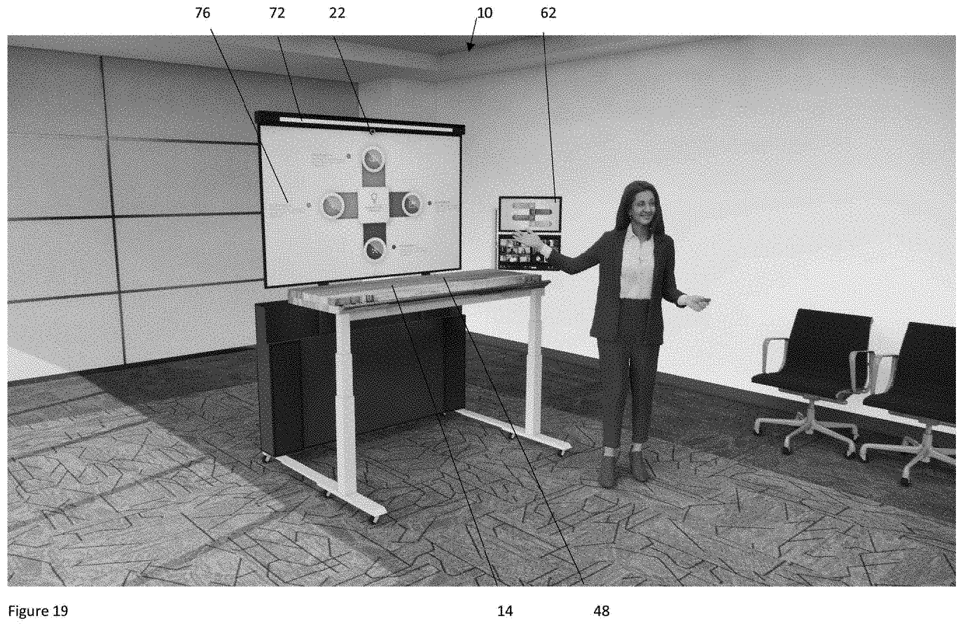

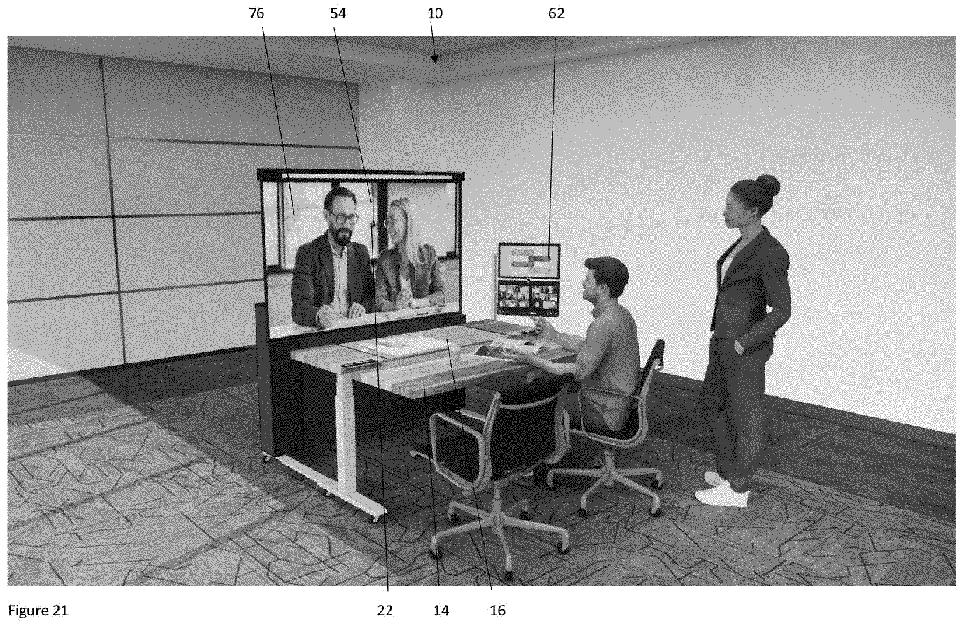

The vertical display device 76 includes a multifunctional top bar 72 that extends horizontally above a display screen 74 of the vertical display device 76. The multifunctional bar 72 has a light strip 78 that can be illuminated to improve the lighting of the users of the table 10, and two speakers 28 arranged on either side of the light strip 78 to provide stereo sound. The multifunctional bar 72 also carries an adjustable user facing camera arm 54, as can be seen in FIG. 21, and an adjustable table facing camera arm 56, as can be seen in FIG. 17. The adjustable user facing camera arm 54 extends vertically downwardly from the multifunctional bar 72 in front of the display screen 74 of the vertical display device 76, and carries a user facing camera 22. The adjustable user facing camera arm 54 has a telescoping mechanism that allows the user facing camera 22 to be extended downwardly from the multifunctional bar 72 to the extended position shown in FIG. 18, and retracted upwardly towards the multifunctional bar 72 to the retracted position shown in FIG. 19. In at least some modes of operation, the user facing camera 22 is preferably positioned at approximately eye level with a user or users of the table 10, to assist in providing a sense of eye contact during video conferencing. In some embodiments of the invention, the user facing camera 22 may include a tilting mechanism that allows the user facing camera 22 to be angled upwardly and/or downwardly relative to horizontal, so that the camera 22 can be angled to face towards the user or users of the table 10 even when the camera 22 is positioned above or below the eye level of the user or users. When the user facing camera 22 is retracted as in FIG. 19, this can optionally be referred to as normal video conferencing mode, and when the user facing camera 22 is extended as in FIG. 18, this can optionally be referred to as full telepresence mode.

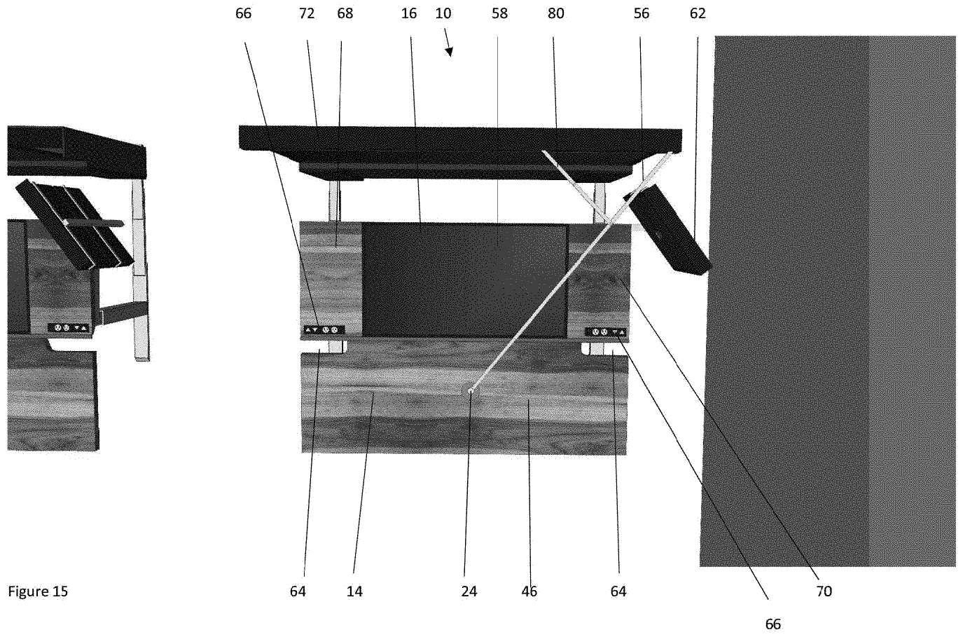

The adjustable table facing camera arm 56 is pivotally attached to the right side of the multifunctional bar 72 and can pivot forwardly from the retracted position shown in FIG. 20, in which the adjustable table facing camera arm 56 is concealed within the multifunctional bar 72, to the fully extended position shown in FIG. 15, in which the table facing camera 24 is positioned above the desk top surface 46. Preferably, the adjustable table facing camera arm 56 has a telescoping mechanism that allows the length of the adjustable table facing camera arm 56 to be extended when in the fully extended position shown in FIG. 15, and retracted to a shorter length when in the retracted position shown in FIG. 20.

As can be seen in FIG. 15, a secondary support arm 80 extends between the multifunctional bar 72 and the adjustable table facing camera arm 56. The secondary support arm 80 is pivotally attached to the adjustable table facing camera arm 56 and slideably and pivotally attached to the multifunctional bar 72, so as to permit the adjustable table facing camera arm 56 to pivot relative to the multifunctional bar 72. The pivoting and sliding action of the secondary support arm 80 can be seen by comparing the fully extended position shown in FIG. 15 to the partially extended position shown in FIG. 17. The secondary support arm 80 gives the adjustable table facing camera arm 56 a triangular base with an additional point of support on the multifunctional bar 72, which helps to stabilize the table facing camera 24 and prevent the table facing camera 24 from capturing shaky or unsteady images of the desk top surface 46.

In some embodiments of the invention, the table facing camera 24 has a swivel mechanism that allows the rotational position of the table facing camera 24 to be adjusted relative to a vertical axis passing through the table facing camera 24. This allows the table facing camera 24 to remain in a fixed orientation relative to the table top 14 as the adjustable table facing camera arm 56 pivots between different positions, such as the partially extended position shown in FIG. 17 and the fully extended position shown in FIG. 15. Alternatively, in some embodiments of the invention the table facing camera 24 might not include a swivel mechanism, and the camera 24 could have a fixed orientation relative to the adjustable table facing camera arm 56.

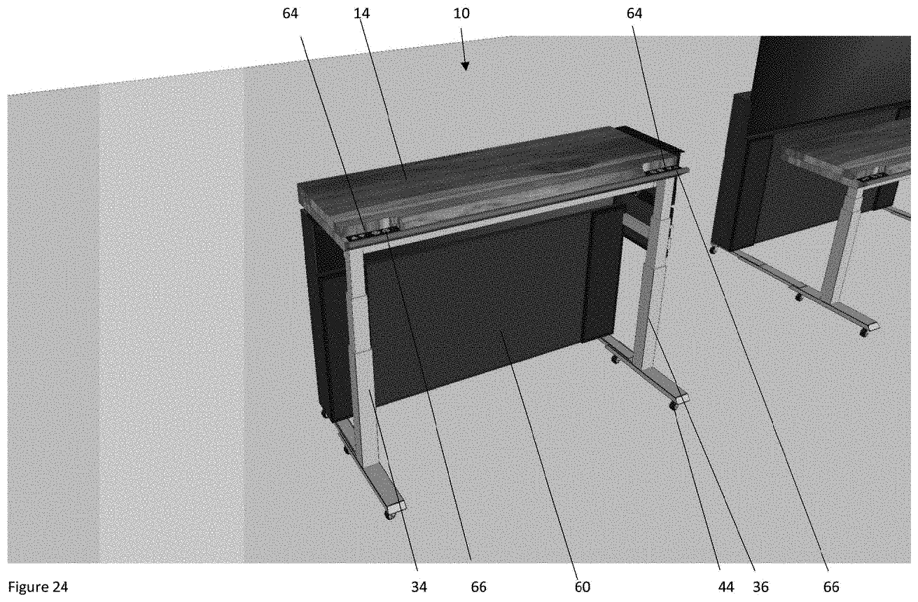

As can be seen in FIG. 12, the side display assembly 62 includes a side arm 42 that is attached to the rear right corner of the table display assembly 58, and which supports two side display devices 26. The side display devices 26 are electronic devices that are capable of displaying video images, such as television screens, computer monitors, or tablets. As can be seen in FIG. 12, the two side display devices 26 are arranged in a stacked orientation, with one side display device 26 arranged above the other side display device 26. Any other desired orientation could be used instead. The side display devices 26 may be used to display any desired images, such as a slide show or other electronic work products. If the users of the table 10 are engaged in a video conference with multiple other participants, smaller video images or some of the participants may be displayed on one or both of the side display devices 26. The side arm 42 is retractable to a retracted position, as shown in FIG. 24, in which the side display devices 26 do not extend above the top of the table top 14.

Similarly to the previous embodiment, the haptic bar 30 is a touch sensitive bar that sits between the table top 14 and the table display assembly 58. The haptic bar 30 can be used for a greeting protocol, or for other possible uses as described in more detail below.

The table 10 shown in FIGS. 12 to 30 can be used in much the same ways as the table 10 shown in FIGS. 1 to 11. Various possible uses of the table 10 shown in FIGS. 12 to 30 will now be described with reference to the drawings.

As can be seen in FIG. 12, the table 10 can be used for video conferencing. When in the video conferencing or full telepresence mode shown in FIG. 12, the table top 14 is arranged extending horizontally forwardly from the table display assembly 58, with the desk top surface 46 providing a surface for users to place work products and/or their hands. The adjustable table facing camera arm 56 is fully extended, with the table facing camera 24 positioned over the table top 14 and capturing video images of the desk top surface 46. The video images of the desk top surface 46 in location A are displayed on the table display device 16 at location B, and vice versa, to give the participants a sense of having a shared table surface. Preferably the images displayed on the table display device 16 are life sized.

The user facing camera 22 captures video images of the participants at the front of the table 10 at location A, who may be standing or sitting, which are then displayed on the vertical display device 76 at location B, and vice versa. The images displayed on the vertical display device 76 are preferably life sized, to give an enhanced sense of presence.

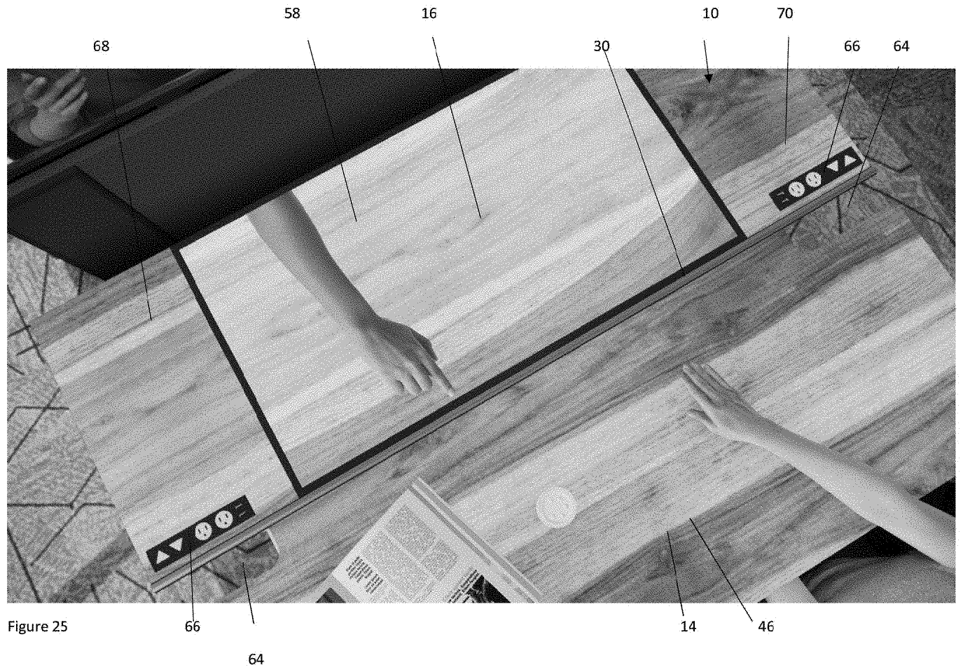

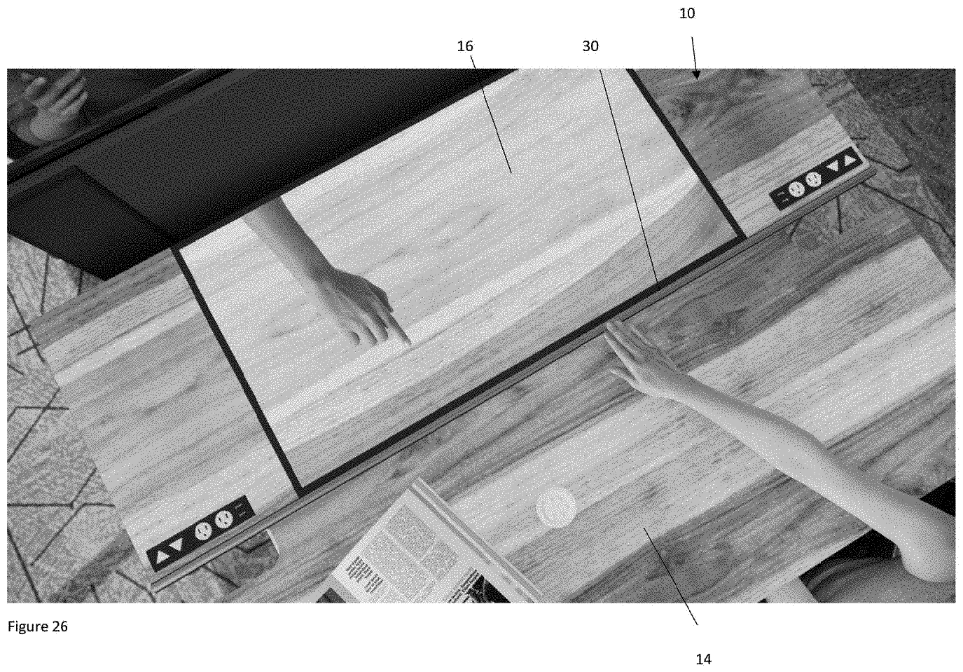

Referring to FIGS. 25 to 27, the haptic bar 30 may optionally be used for a greeting protocol, to give an enhanced sense of physical presence via touch sensations. When a participant at location B touches the haptic bar 30 without a participant at location A also touching the haptic bar 30, as shown in FIG. 25, the haptic bar 30 preferably remains motionless. Likewise, when a participant at location A touches the haptic bar 30 without a participant at location B also touching the haptic bar 30, as shown in FIG. 26, the haptic bar 30 preferably remains motionless. Optionally, when a participant at one location touches the haptic bar 30, a notification is sent to the participants at the other location, such as by illuminating the light strip 78 or playing a sound on the speakers 28, to signal to the other participants that the greeting protocol has been initiated.

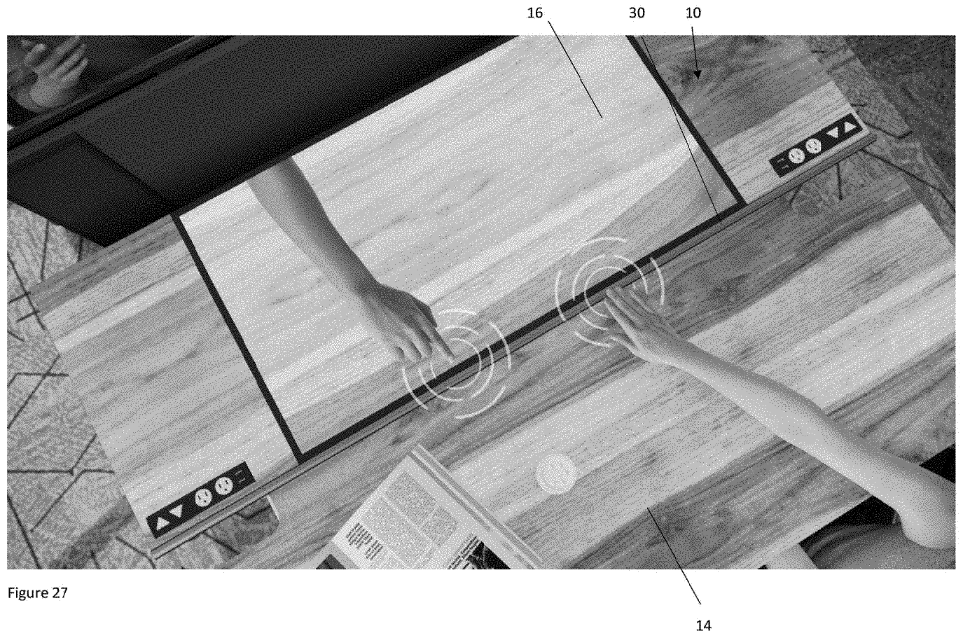

When participants at both locations touch the haptic bar 30 simultaneously, as shown in FIG. 27, the haptic bar preferably begins to vibrate gently. The vibrations preferably occur in pulses that simulate a human heart beat, and which are synchronized so as to occur simultaneously for the participants at each location. The pulses may occur, for example, approximately once every second. The haptic bar 30 may also be referred to as the haptic touch interface 30, and does not necessarily need to be in the form of a bar or strip.

Being able to see the hand of the participant at the other location reaching across the table 10, via the images displayed on the table display device 16, and feeling the pulses on the haptic bar 30 preferably provides a strong sense of sharing a physical space. This preferably helps to foster effective communication and collaboration. The shared sense of physical space may also help the participants to feel more comfortable. For example, for some individuals, including potentially some individuals with autism spectrum disorder, being able to experience a technologically mediated sense of physical touch may help to increase comfort and facilitate effective communication.

The haptic bar 30 could be used for a number of different purposes. For example, the haptic bar 30 could be used as a video game control device that can stimulate the touch or hitting of a ball during a video game; as a musical instrument interface; as a special needs feedback control device; and/or as a therapeutic haptic interface for individuals with autism spectrum disorder.

In one preferred embodiment, the haptic bar 30, which can also be referred to as the web table haptic feedback sensor 30, is a thin plastic strip that has a small actuator (motor or other vibratory mechanism) attached under its surface that is activated when people on both ends of the videoconference touch it at the same time. When activated, it sends a vibrational pulse through the length of the bar 30 at a rate of 70 beats per minute (the global average human heart rate) to simulate a human heartbeat. It can be used as a greeting protocol similar to a hand shake to provide users with a haptic (touch) interface sensation that simulates the sensation of touching a person's finger. The life-size projection of the remote desktop and thus the other person's hand that is projected on the table display device 16, or desk display 16, enhances the sensation of remote presence and thus adds a physical multimodal element to the remote communication.

The height of the support bar 32, and thus the height of the table top 14 and the table display assembly 58, can be adjusted by extending or retracting the legs 34, 36. For example, the table top 14 can be positioned at the lowered position shown in FIG. 12 for participating in a teleconference while sitting, or raised to the raised position shown in FIG. 18 for participating in a teleconference while standing. As can be seen in FIG. 23, the table top 14 and the table display device 58 can also be raised to make space for the vertical display assembly 60 to be stored under the table display device 58. When in the desk or storage mode shown in FIG. 23, the table 10 can be more easily moved from one location to another by rolling the table 10 in any direction using the swivel wheels 44. The dimensions of the table 10 when in the desk or storage mode shown in FIG. 23 are preferably selected so that the table 10 can fit through doorways and into elevators. The configuration shown in FIG. 23 can also be referred to as the closed mode, with the table top 14 up at bar height. When in the configuration shown in FIG. 23, the table 10 can be used as a bar height table 10. Optionally, the table display assembly 58 has a dock on its bottom surface that couples to the top of the vertical display assembly 60 when the vertical display assembly 60 is positioned under the table display assembly 58 as in FIG. 23. The coupling of the vertical display assembly 60 to the table display assembly 58 preferably helps to hold the vertical display assembly 60 and the table display assembly 58 together and improve stability when the table 10 is being transported.

As can be seen in FIG. 17, in some embodiments of the invention the adjustable table facing camera arm 56 can be arranged at a partially extended position, with the table facing camera 24 positioned above the table display device 16. This may be useful, for example, to capture video images of a user's hand interacting with the table display device 16, for example while playing a video game. When the table top 14 is not folded over the table display device 16 and the table display device 16 is exposed, as in FIG. 17, the table 10 can be referred to as being in an open mode or a table open mode.

As can be seen in FIG. 19, the table 10 can also be used in a presentation mode, in which the vertical display device 76 can be used, for example, to display a slideshow or other work product, rather than life size images of teleconference participants. The table top 14 can also be folded over the table display assembly 58 when the table display assembly 58 is not in use, to reduce the back to front dimensions of the table 10. When in the folded over position shown in FIG. 19, the control panels 66 remain accessible via the cutouts 64. When in the presentation mode shown in FIG. 19, the adjustable user facing camera arm 54 and the adjustable table facing camera arm 56 can also be retracted.

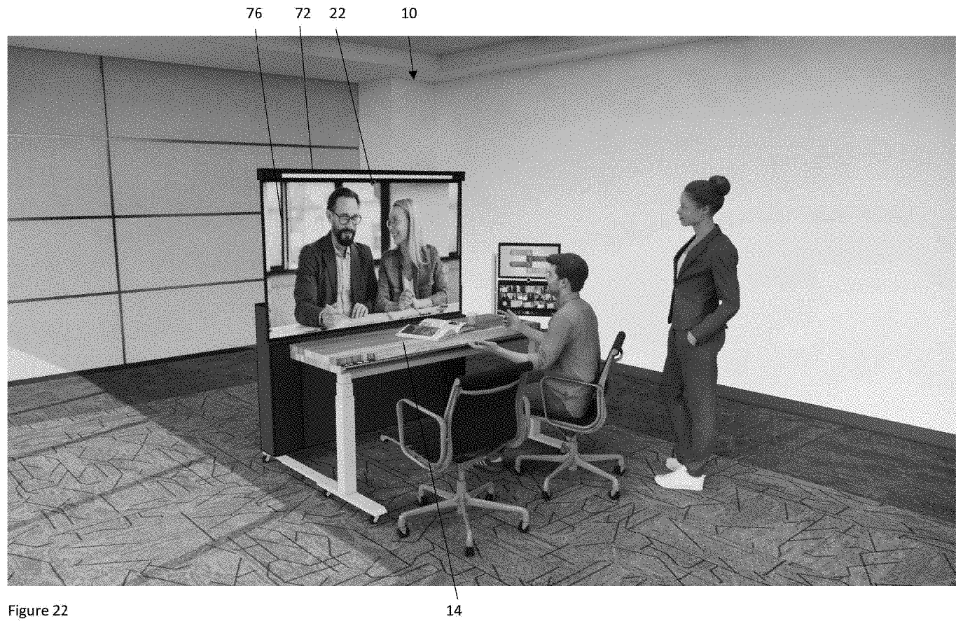

As shown in FIG. 22, the table 10 can also be used for video conferencing without use of the table display device 16. When the table display device 16 is not being used, the table top 14 can be folded over the table display assembly 58, and the adjustable table facing camera arm 58 can be retracted.

When the table 10 is in the desk or storage mode shown in FIG. 23, the table 10 can be used as a desk or bar, or can be placed out of the way in storage. The control panels 66 remain accessible when in the desk or storage mode, so that, for example, a user can use the power outlets to charge a laptop or use the USB ports to charge a phone, while using the table 10 as a standup desk.

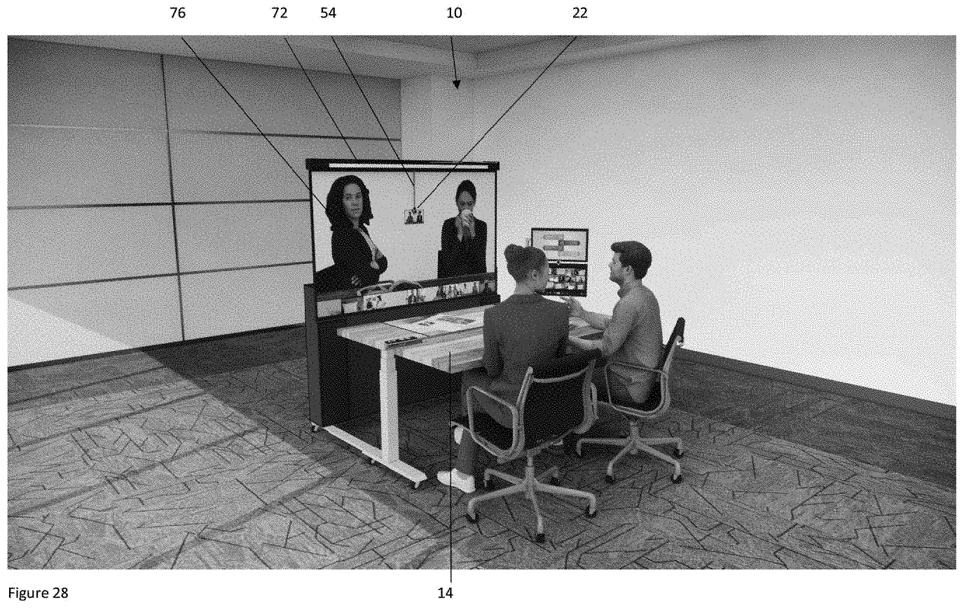

The table 10 preferably has a variety of different display styles that a user can choose from. For example, one possible display style for the vertical display device 76 is shown in FIG. 28. In this display style, the vertical display device 76 at location A displays life size images of the participants at location B, and also displays a small image of the participants at location A in the center of the screen. The adjustable user facing camera arm 54 is also extended so that the user facing camera 22 is positioned at approximately the same location as the small image of the participants at location A. This display style preferably helps to maintain eye contact between the participants. In particular, many people tend to look at themselves when participating in a video conference. As the camera 22 is located at approximately the same position as the image of themselves, participants who look at themselves will appear to be looking into the camera 22.

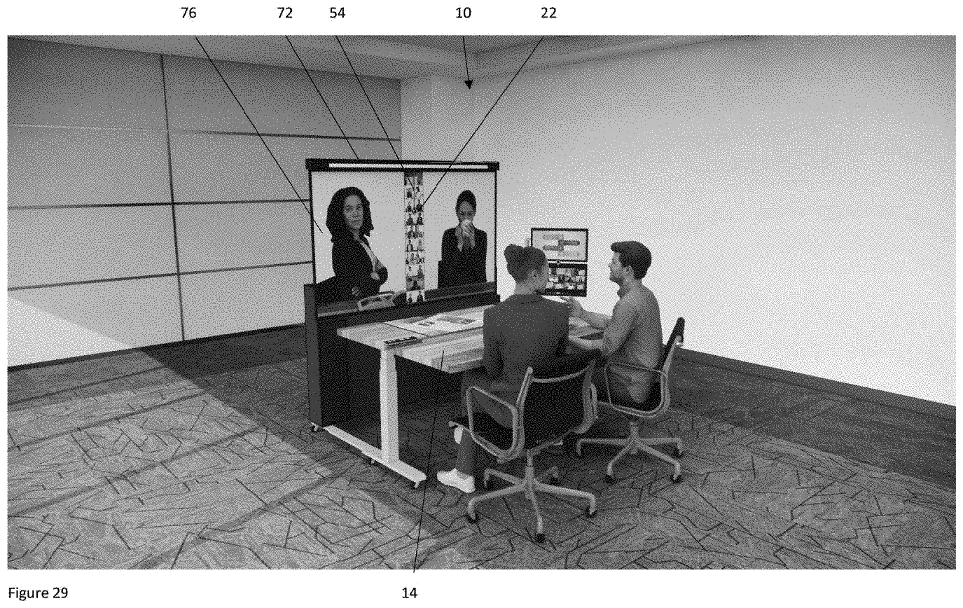

The vertical display device 76 may also be used to display smaller images of other participants in the video conference, for example if the video conference involves participants from a number of different locations. In the display style shown in FIG. 28, smaller images of the other participants are arranged horizontally across the bottom of the screen. The images of the other participants can also be arranged vertically through the center of the screen, as in the display style shown in FIG. 29. Optionally, users of the table 10 may be able to select the size and location of the images of each of the participants in the video conference on the vertical display device 76. The table 10 could be configured so that whoever is talking is shown life size on the vertical display device 76, or so that the life size images remain locked on a selected participant or participants.

In one preferred embodiment, the web table 10 picture-in-picture can be arranged in a way that helps enhance the sensation of eye contact and thus human presence. This is accomplished by lowering the camera 22 from the middle of the multifunctional bar 72 to a point approximately ⅓ of the way down the vertical display device 76 using a thin support beam 54 that holds the wires from the camera 22, as shown in FIG. 28. In this version the camera 22 is positioned at roughly the same height as the eyes on the far end user's faces. The picture-in-picture is positioned at the same location as the camera 22 (either beside the camera 22 or slightly above or below it), which encourages users to look at themselves and thus provides direct eye contact.

Referring to FIG. 29, in this version the picture-in-picture will remain as it is in FIG. 28, but if numerous other web tables 10 are connected the other sites will appear in a vertical row of images in the middle. Optionally, it can be set up so that the web table 10 that has someone talking will appear life-size on the large screen in a similar way as a conventional multiconference call. This iteration allows many web tables 10 to be connected and still provides the sensation of eye contact presence as when two tables 10 are connected.

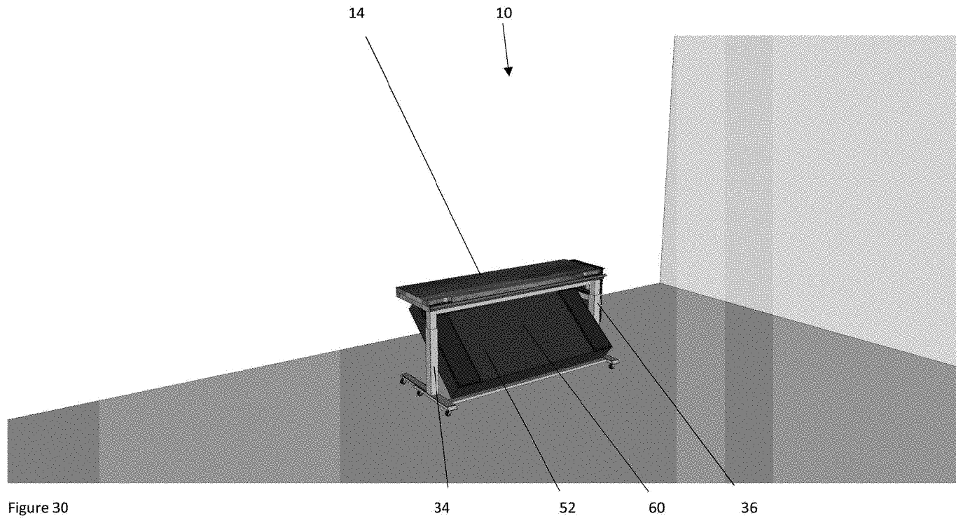

In some embodiments of the invention, the table 10 optionally includes a mechanism that allows the vertical display assembly 60 to be tilted to a diagonal position when stowed under the table display assembly 58, as shown in FIG. 30. When at the diagonal position, the vertical display assembly 60 takes up less space in the vertical direction, which allows the height of the table display assembly 58 to be lowered. This allows the table 10 to adopt an even more compact storage configuration, as compared to when the vertical display assembly 60 is positioned vertically as shown in FIG. 24.

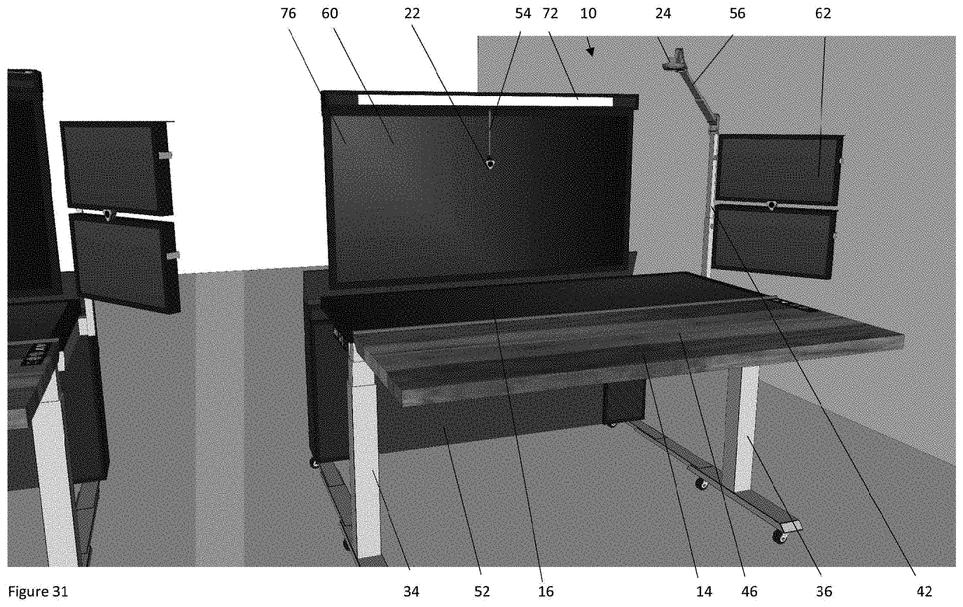

Reference is now made to FIGS. 31 to 33, which show a multimodal, mobile, video conferencing table 10 in accordance with a third embodiment of the present invention. Like numerals are used to represent like components.

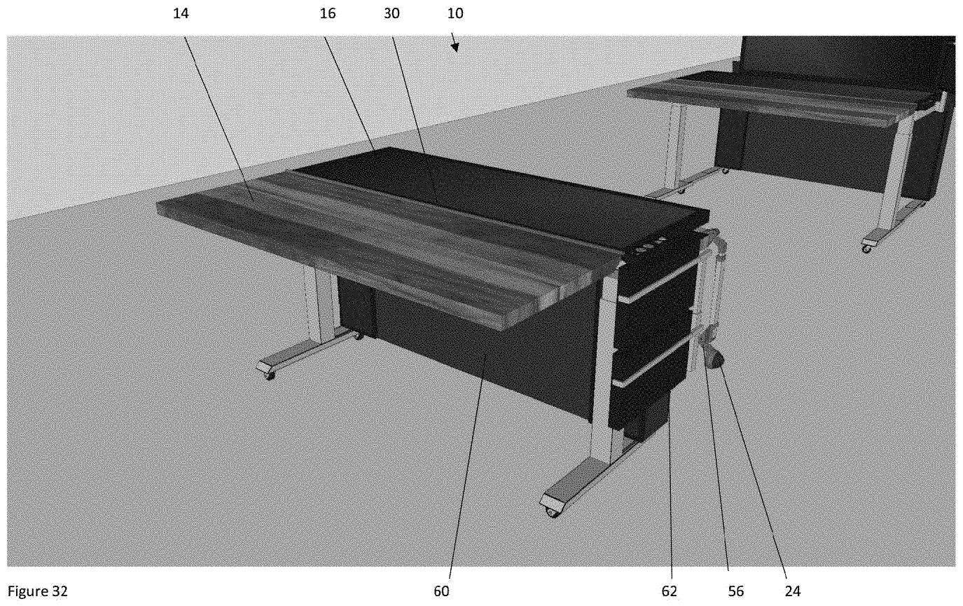

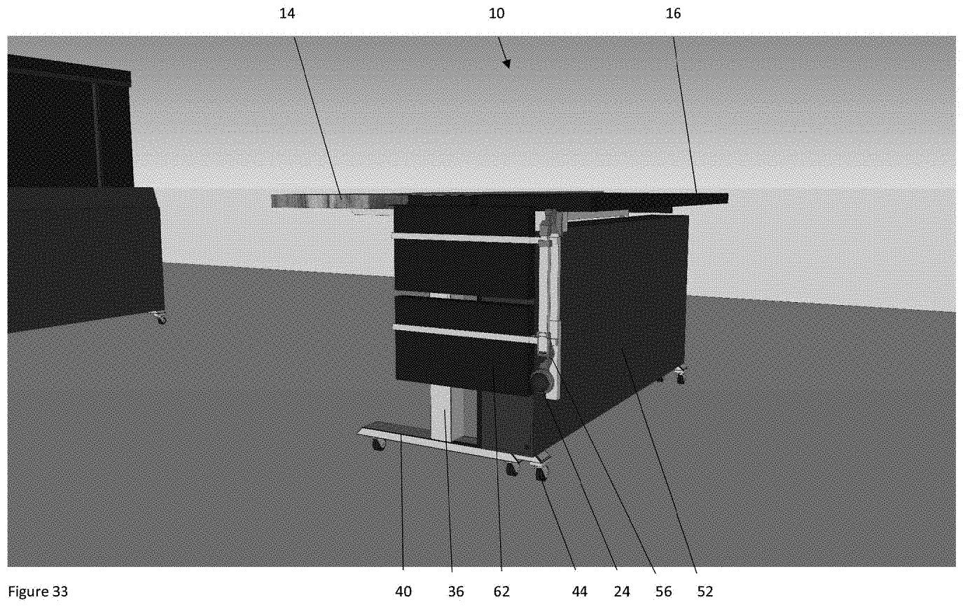

The table 10 shown in FIGS. 31 to 33 is generally similar to the table 10 shown in FIGS. 12 to 30, and can be used in much the same ways as the table 10 shown in FIGS. 12 to 30. The two main differences are that the table display device 16 has approximately the same dimensions as the table top 14, and does not have a left side table portion 68 and a right side table portion 70; and that the adjustable table facing camera arm 56 extends from the side arm 42 rather than from the multifunctional bar 72. The adjustable table facing camera arm 56 preferably has a telescoping mechanism that allows the arm 56 to be extended and retracted, as well as a swivel mechanism that allows the angular position of the arm 56 to be adjusted. As can be seen in FIGS. 32 and 33, the adjustable table facing camera arm 56 can be retracted and folded to a retracted position below the height of the table display device 16.

Although only one user facing camera 22 is shown in the drawings, additional user facing cameras 22 could also be provided. For example, two cameras 22 could be placed on either side of the vertical display device 76, and the images from the two cameras 22 could be combined by a processor to generate an interpolated video image. The interpolated video image may, for example, adjust the positioning of the participants eyes so that a sense of eye contact can be maintained, even when the participants are not looking directly into the cameras 22. The interpolated video could also present participants on the vertical display device 76 in three dimensions.

Preferably, the web table 10 can be set up in a series of ways that enhance the experience of remote presence by allowing the web table 10 to be transformed to provide a series of possible human interaction situations.

In the most basic mode, as shown in FIG. 23, the table 10 is raised to the “bar” type position and the large screen 76 is in the lowered position, the table 14 raised and the screen 76 moved under the table 14. In this mode the web table 10 can be easily moved between spaces in an office, stored or used as a table. The speakers 28 are positioned to provide good sound quality and the table surface 48 is usable as a convention table surface.

In the second iteration as shown in FIG. 30, the screen 76 when in the lowered position can be tilted inwards at the bottom to allow the table 10 to be used at a conventional table height. This configuration provides the added benefit of more flexibility in its use, but requires a more robust mechanism for tilting the screen 76, which may add complexity and cost.

Once the screen 76 has been moved out from the table 14, as in FIGS. 19 and 20, the screen 76 can be raised to its highest position and the secondary smaller screen or screens 26 raised to allow for use in a presentation or other manner.

The table 14 can also be lowered and the system used as a table meeting situation, as shown in FIG. 22.

In full telepresence mode, as shown in FIG. 12, the table 14 opens up to reveal a second screen 16 embedded into the table surface and a camera 24 on a boom 56 swings out that looks down at the table surface, either over the screen 16 for game playing or over the unfolded table surface 46 for full telepresence. When the camera 24 is in the telepresence mode it projects a life-size image of the other person's table surface 46, which increases the sensation of human presence.

It will be understood that, although various features of the invention have been described with respect to one or another of the embodiments of the invention, the various features and embodiments of the invention may be combined or used in conjunction with other features and embodiments of the invention as described and illustrated herein.

Although this disclosure has described and illustrated certain preferred embodiments of the invention, it is to be understood that the invention is not restricted to these particular embodiments. Rather, the invention includes all embodiments which are functional, electrical, computational, optical, or mechanical equivalents of the specific embodiments and features that have been described and illustrated herein.

We claim:

1. A video conferencing device comprising:
a first video display device;
a second video display device;
a table top;
a user facing camera; and
a table facing camera;
wherein in at least a first mode of operation of the video conferencing device:
the user facing camera captures images of a user positioned in front of the video conferencing device at a first location;
the table facing camera captures images of the table top at the first location;
the first video display device displays images of a communication partner at a second location; and
the second video display device displays images of a work surface at the second location.

2. The video conferencing device according to claim 1, wherein, when the video conferencing device is in the first mode of operation:
the first video display device is positioned vertically and facing forwardly;
the second video display device is positioned horizontally and facing upwardly; and
the table top is positioned horizontally, with a table top surface of the table top facing upwardly.

3. The video conferencing device according to claim 2, further comprising a table facing camera support member that is attached to a top portion of the first video display device, the table facing camera support member carrying the table facing camera;
wherein the table facing camera support member is movable relative to the first video display device between an extended position, in which the table facing camera is positioned above the table top, and a retracted position, in which the table facing camera is retracted towards the first video display device; and
wherein, when the video conferencing device is in the first mode of operation, the table facing camera support member is in the extended position.

4. The video conferencing device according to claim 3, wherein the table facing camera support member comprises:
a primary support arm having a first end that is pivotally connected to the top portion of the first video display device and a second end that carries the table facing camera; and
a secondary support arm having a first end that is pivotally and slideably connected to the top portion of the first video display device and a second end that is connected to the primary support arm.

5. The video conferencing device according to claim 4, wherein the primary support arm has a telescoping mechanism that allows a length of the primary support arm to be adjusted.

6. The video conferencing device according to claim 2, further comprising a user facing camera support member that is attached to a top portion of the first video display device, the user facing camera support member carrying the user facing camera;
wherein the user facing camera support member is movable relative to the first video display device between a retracted position and an extended position, the user facing camera being positioned closer to the top portion of the first video display device when the user facing camera support member is in the retracted position than when the user facing camera support member is in the extended position; and
wherein, when the first video display device is positioned vertically, movement of the user facing camera support member between the retracted position and the extended position moves the user facing camera vertically.

7. The video conferencing device according to claim 1, further comprising a haptic interface;
wherein, in at least the first mode of operation, the haptic interface is configured to vibrate when:
the user touches the haptic interface at the first location, and the communication partner simultaneously touches a haptic device at the second location.

8. The video conferencing device according to claim 7, wherein the haptic interface comprises a touch sensitive strip that is positioned between the second video display device and the table top.

9. The video conferencing device according to claim 8, wherein, when the video conferencing device is in the first mode of operation and the communication partner touches the haptic device at the second location, the second video display device displays images of the communication partner touching the haptic device at the second location.

10. The video conferencing device according to claim 7, wherein the haptic interface is configured to vibrate rhythmically at a rate of about 70 pulses per minute.

11. The video conferencing device according to claim 2, wherein the first video display device is movable relative to the second video display device between a display position and a stowed position;
wherein, when in the display position, the first video display device is positioned rearwardly of the second video display device and extends above the second video display device;
wherein, when in the stowed position, the first video display device is positioned beneath the second video display device; and
wherein, when the video conferencing device is in the first mode of operation:
the first video display device is in the display position; and
the second video display device is positioned rearwardly of the table top.

12. The video conferencing device according to claim 11, further comprising:
support legs that support the second video display device;
support feet that are positioned at bottom ends of the support legs; and
a storage member that is supported by the support feet;
wherein the storage member has an internal compartment for receiving the first video display device;
wherein the first video display device extends vertically upwardly from the storage member when in the display position;
wherein the first video display device is received in the internal compartment of the storage member when in the stowed position;
wherein the support feet are movable relative to the support legs between an extended position and a retracted position;
wherein, when the support feet are in the extended position, the first video display device is positioned rearwardly of the second video display device;
wherein, when the support feet are in the retracted position, the first video display device is positioned below the second video display device;
wherein the support feet are in the extended position when the first video display device is in the display position; and
wherein the support feet are in the retracted position when the first video display device is in the stowed position.

13. The video conferencing device according to claim 12, wherein the storage member connects to an underside of the second video display device when the first video display device is in the stowed position.

14. The video conferencing device according to claim 12, wherein the support legs are movable relative to the support feet between a raised position and a lowered position; and
wherein a height of the second video display device is selectable by moving the support legs between the raised position and the lowered position.

15. The video conferencing device according to claim 2, wherein the table top is moveable between an unfolded position and a folded position;
wherein, when in the unfolded position, the table top is positioned horizontally and forwardly of the second video display device, with the table top surface of the table top facing upwardly; and
wherein, when in the folded position, the table top is positioned horizontally and above the second video display device, with the table top surface of the table top facing downwardly.

16. The video conferencing device according to claim 5, further comprising a user facing camera support member that is attached to the top portion of the first video display device, the user facing camera support member carrying the user facing camera;
wherein the user facing camera support member is movable relative to the first video display device between a retracted position and an extended position, the user facing camera being positioned closer to the top portion of the first video display device when the user facing camera support member is in the retracted position than when the user facing camera support member is in the extended position; and
wherein, when the first video display device is positioned vertically, movement of the user facing camera support member between the retracted position and the extended position moves the user facing camera vertically.

17. The video conferencing device according to claim 16, further comprising a haptic interface;
wherein, in at least the first mode of operation, the haptic interface is configured to vibrate when:
the user touches the haptic interface at the first location, and the communication partner simultaneously touches a haptic device at the second location;
wherein the haptic interface comprises a touch sensitive strip that is positioned between the second video display device and the table top;
wherein, when the video conferencing device is in the first mode of operation and the communication partner touches the haptic device at the second location, the second video display device displays images of the communication partner touching the haptic device at the second location; and
wherein the haptic interface is configured to vibrate rhythmically at a rate of about 70 pulses per minute.

18. The video conferencing device according to claim 17, wherein the first video display device is movable relative to the second video display device between a display position and a stowed position;
wherein, when in the display position, the first video display device is positioned rearwardly of the second video display device and extends above the second video display device;
wherein, when in the stowed position, the first video display device is positioned beneath the second video display device;
wherein, when the video conferencing device is in the first mode of operation:
the first video display device is in the display position; and
the second video display device is positioned rearwardly of the table top; and
wherein the first video display device connects to an underside of the second video display device when the first video display device is in the stowed position.

19. The video conferencing device according to claim 18, further comprising:
support legs that support the second video display device;
support feet that are positioned at bottom ends of the support legs; and
a storage member that is supported by the support feet;
wherein the storage member has an internal compartment for receiving the first video display device;
wherein the first video display device extends vertically upwardly from the storage member when in the display position;
wherein the first video display device is received in the internal compartment of the storage member when in the stowed position;
wherein the support feet are movable relative to the support legs between an extended position and a retracted position;
wherein, when the support feet are in the extended position, the first video display device is positioned rearwardly of the second video display device;
wherein, when the support feet are in the retracted position, the first video display device is positioned below the second video display device;
wherein the support feet are in the extended position when the first video display device is in the display position;
wherein the support feet are in the retracted position when the first video display device is in the stowed position;
wherein the support legs are movable relative to the support feet between a raised position and a lowered position; and
wherein a height of the second video display device is selectable by moving the support legs between the raised position and the lowered position.

20. The video conferencing device according to claim 19, wherein the table top is moveable between an unfolded position and a folded position;
wherein, when in the unfolded position, the table top is positioned horizontally and forwardly of the second video display device, with the table top surface of the table top facing upwardly;
wherein, when in the folded position, the table top is positioned horizontally and above the second video display device, with the table top surface of the table top facing downwardly; and
wherein the support feet have wheels.
